(19) United States
(12) Patent Application Publication
(10) Pub. No.: US 2020/0292861 A1
(43) Pub. Date: Sep. 17, 2020

(54) LIQUID CRYSTAL DISPLAY DEVICE

(71) Applicant: FUJIFILM Corporation, Tokyo (JP)

(72) Inventors: Tatsuya IWASAKI, Kanagawa (JP); Yuki NAKAMURA, Kanagawa (JP); Katsufumi OHMURO, Kanagawa (JP)

(73) Assignee: FUJIFILM Corporation, Tokyo (JP)

(21) Appl. No.: 16/885,755

(22) Filed: May 28, 2020

Related U.S. Application Data
(63) Continuation of application No. PCT/JP2018/046777, filed on Dec. 19, 2018.

(30) Foreign Application Priority Data
Dec. 19, 2017 (JP) 2017-243222
Dec. 3, 2018 (JP) 2018-226878

(51) Int. Cl. G02F 1/13363; G02F 1/1335

(52) U.S. Cl. CPC G02F 1/13363; G02F 1/133528; G02F 2413/02; G02F 2001/133531; G02F 1/133514

(57) ABSTRACT

The present invention provides a liquid crystal display device which is capable of achieving both reduction in thickness of a device and improvement of display performance such as prevention of light leakage, suppression of display unevenness in a hot and humid environment, and suppression of a change in display performance. The liquid crystal display of the present invention includes at least a first polarizer, a second optically anisotropic layer, a first optically anisotropic layer, a liquid crystal cell, and a second polarizer in this order, in which the first optically anisotropic layer satisfies predetermined Re (550) and Rth (550), the second optically anisotropic layer satisfies predetermined Re (550) and Rth (550), and the film thickness of the first optically anisotropic layer and the second optically anisotropic layer in a laminated form is 8 μm or less.

### CROSS-REFERENCE TO RELATED APPLICATIONS

This application is a Continuation of PCT International Application No. PCT/JP2018/046777 filed on Dec. 19, 2018, which claims priority under 35 U.S.C. § 119(a) to Japanese Patent Application No. 2017-243222 filed on Dec. 19, 2017 and Japanese Patent Application No. 2018-226878 filed on Dec. 3, 2018. Each of the above applications is hereby expressly incorporated by reference, in its entirety, into the present application.

### BACKGROUND OF THE INVENTION

### 1. Field of the Invention

The present invention relates to an in-plane switching (IPS) mode liquid crystal display device.

### 2. Description of the Related Art

In a liquid crystal display device, a lateral electric field driving type such as an IPS mode or a fringe field switching (FFS) mode with satisfactory visual field characteristics has attracted attention. In particular, for example, the IPS mode has an advantage in that a device in the IPS mode has excellent viewing angle characteristics as compared with a liquid crystal display device in a twisted nematic (TN) mode or a vertical alignment (VA) mode as described in JP2002-055341A.

### SUMMARY OF THE INVENTION

In recent years, with a progression of reduction in thickness of a liquid crystal display device, there is a demand for reduction in thickness of members (for example, a polarizing plate).

Meanwhile, in a liquid crystal cell in an IPS mode or FFS mode in which a liquid crystal compound is aligned by photo-alignment or a rubbing treatment, further improvement of light leakage as viewed in an oblique direction is required.

Further, as required performance of the liquid crystal display device, it is required that display unevenness does not occur even after the liquid crystal display device is allowed to stand in a hot and humid environment. However, in a conventional liquid crystal display device, there is a problem in that since a member to be attached to a liquid crystal cell such as a polarizer is likely to be deformed in a hot and humid environment, distortion occurs in the liquid crystal cell, a phase difference (in a retardation or slow axis direction) of an optically anisotropic layer which has been attached is changed, and thus display unevenness is likely to occur.

Further, in recent years, there has been an increasing demand for suppressing a change in display performance with time due to expansion of panel applications such as an in-vehicle panel and a mobile panel. In particular, there is a problem in that the performance of the optically anisotropic layer used for improving the viewing angle deteriorates with time and this results in deterioration of the impression of the display performance.

That is, achievement of both reduction in thickness of a liquid crystal display device and improvement of display performance (such as prevention of light leakage, suppression of display unevenness in a hot and humid environment, and suppression of a change in display performance) has been required, but the techniques of the related art were not able to satisfy all these requirements.

The present invention has been made in consideration of the above-described circumstances, and an object thereof is to provide a liquid crystal display device which is capable of achieving both reduction in thickness and improvement of display performance such as prevention of light leakage, suppression of display unevenness in a hot and humid environment, and suppression of a change in display performance.

As the result of intensive research conducted by the present inventors in order to solve the above-described problems, it was found that in a case where a polarizer and an optically anisotropic layer having an in-plane retardation with a predetermined value or greater are adjacent to each other, the phase difference and the polarizer deteriorate with time due to the interaction between the optically anisotropic layer and the polarizer. The present inventors found that all the above-described problems can be solved by laminating two optically anisotropic layers and a polarizer in a predetermined order so that the optically anisotropic layers satisfy a predetermined retardation relationship and applying a polarizing plate obtained by thinning the optically anisotropic layers to a liquid crystal display device, thereby completing the present invention.

That is, the present inventors found that the above-described problems can be solved by the following configurations.

(1) A liquid crystal display device comprising at least: a first polarizer; a second optically anisotropic layer; a first optically anisotropic layer; a liquid crystal cell; and a second polarizer, in this order, in which the liquid crystal cell includes a pair of substrates, at least one of which has an electrode, disposed to oppose each other and a liquid crystal layer disposed between the pair of substrates and having a controlled alignment, an electric field which has a component parallel to the substrate having the electrode is formed by the electrode, an absorption axis of the first polarizer is parallel with a slow axis of the first optically anisotropic layer, the absorption axis of the first polarizer is orthogonal to a slow axis of the liquid crystal layer having a controlled alignment during black display, the absorption axis of the first polarizer is orthogonal to an absorption axis of the second polarizer, an in-plane retardation Re1 (550) of the first optically anisotropic layer at a wavelength of 550 nm and a retardation Rth1 (550) of the first optically anisotropic layer in a thickness direction each satisfy Expression (1) and Expression (2), an in-plane retardation Re2 (550) of the second optically anisotropic layer at a wavelength of 550 nm and a retardation Rth2 (550) of the second optically anisotropic layer in a thickness direction each satisfy Expression (3) and Expression (4), and a film thickness of the first optically anisotropic layer and the second optically anisotropic layer in a laminated form is 8 μm or less.

(2) The liquid crystal display device according to (1), in which the film, thickness of the first optically anisotropic layer and the second optically anisotropic layer in the laminated form is 5 μm or less.

(3) The liquid crystal display device according to (1) or (2), in which the first optically anisotropic layer is a layer in which a rod-like liquid crystal compound is fixed in a state of being aligned in a direction horizontal to a substrate surface.

(4) The liquid crystal display device according to any one of (1) to (3), in which the second optically anisotropic layer is a layer in which the rod-like liquid crystal compound is fixed in a state of being aligned in a direction perpendicular to the substrate surface.

(5) The liquid crystal display device according to any one of (1) to (4), in which an in-plane retardation Re1 (450) of the first optically anisotropic layer at a wavelength of 450 inn and the in-plane retardation Re1 (550) of the first optically anisotropic layer at a wavelength of 550 nm satisfy Expression (5).

(6) The liquid crystal display device according to any one of (1) to (5), in which a retardation Rth2 (450) of the second optically anisotropic layer at a wavelength of 450 nm in the thickness direction and the retardation Rth2 (550) of the second optically anisotropic layer at a wavelength of 550 nm in the thickness direction satisfy Expression (6).

(7) The liquid crystal display device according to any one of (1) to (5), in which a retardation Rth2 (450) of the second optically anisotropic layer at a wavelength of 450 nm in the thickness direction and the retardation Rth2 (550) of the second optically anisotropic layer at a wavelength of 550 nm in the thickness direction satisfy Expression (7).

(8) The liquid crystal display device according to any one of (1) to (7), in which the first optically anisotropic layer and the second optically anisotropic layer are adjacent to each other.

(9) The liquid crystal display device according to any one of (1) to (8), in which a film thickness of a first polarizing plate which includes the first polarizer, the first optically anisotropic layer, and the second optically anisotropic layer is 50 μm or less.

(10) The liquid crystal display device according to any one of (1) to (9), in which the second optically anisotropic layer is bonded to the first polarizer through a polyvinyl alcohol-based adhesive.

(11) The liquid crystal display device according to any one of (1) to (10), in which the second optically anisotropic layer is bonded to the first polarizer through a curable adhesive composition which is cured by being irradiated with active energy rays or being heated.

(12) The liquid crystal display device according to any one of (1) to (11), in which at least one of the first optically anisotropic layer or the second optically anisotropic layer is a layer in which an alignment state of a polymerizable liquid crystal compound is fixed by using an oxime ester-based photopolymerization initiator.

(13) The liquid crystal display device according to any one of (1) to (12), in which the second optically anisotropic layer is formed using a liquid crystal composition which contains at least a liquid crystal compound and a compound represented by Formula (1).

(14) The liquid crystal display device according to any one of (1) to (13), in which the liquid crystal cell includes at least a first pixel region, a second pixel region, and a third pixel region, a first color filter disposed on the first pixel region of the liquid crystal cell, a second color filter disposed on the second pixel region of the liquid crystal cell, and a third color filter disposed on the third pixel region of the liquid crystal cell are provided on a side closer to a. viewing side than the liquid crystal cell, a relationship of λ₁<λ₂<λ₃ is satisfied in a case where a wavelength showing a maximum transmittance of the first color filter is set as λ₁, a wavelength showing a maximum transmittance of the second color filter is set as λ₂, and a wavelength showing a maximum transmittance of the third color filter is set as λ₃, and a retardation Rth (λ₁) of the first color filter at a wavelength λ₁ in the thickness direction and a retardation Rth (λ₂) of the second color filter at a wavelength λ₂ in the thickness direction satisfy Expression (8).

(15) The liquid crystal display device according to any one of (1) to (14), in which a retardation Rth (λ₂) of the second color filter at a wavelength λ₂ in the thickness direction and a retardation Rth (λ₃) of the third color filter at a wavelength in the thickness direction satisfy Expression (9).

According to the present invention, it is possible to provide a liquid crystal display device which is capable of achieving both reduction in thickness and improvement of display performance such as prevention of light leakage, suppression of display unevenness in a hot and humid environment, and suppression of a change in display performance.

### BRIEF DESCRIPTION OF THE DRAWINGS

FIG. 1 is a cross-sectional view illustrating a liquid crystal display device according to one embodiment of a first aspect of the present invention.

### DESCRIPTION OF THE PREFERRED EMBODIMENTS

Hereinafter, the present invention will be described in detail. In this specification, a numerical range represented by using “to” indicates a range including numerical values described before and after “to” as a lower limit and an upper limit.

In the present specification, Re (λ) and Rth (λ) each represent an in-plane retardation at a wavelength λ and a retardation at a wavelength λ in a thickness direction. Unless otherwise specified, the wavelength λ is set to 550 nm.

In this specification, Re (λ) and Rth (λ) are values measured at a wavelength λ using AxoScan OPMF-1 (manufactured by Optoscience. Inc.). By inputting the average refractive index ((Nx+Ny+Nz)/3) and the film thickness (d (μm)) using AxoScan, the slow axis direction (°), “Re(λ)=R0 (λ)”, and “Rth(λ)=((Nx+Ny)/2−Nz)×d” are calculated.

In the present invention, the refractive indices Nx, Ny, and Nz are measured with an Abbe refractometer (NAR-4T, manufactured by Atago Co., Ltd.) using a sodium lamp (λ=589 nm) as a light source.

In a case of measuring the wavelength dependence, a multi-wavelength Abbe refractometer DR-M2 (manufactured by Atago Co., Ltd.) can be used in combination with an interference filter.

In addition, values from Polymer Handbook (John Wiley & Sons, Inc.) and catalogs of various optical films can also be used.

Examples of average refractive index values of main optical films are as follows: cellulose acylate (1.48), a cycloolefin polymer (1.52), polycarbonate (1.59), polymethyl methacrylate (1.49), and polystyrene (1.59).

The average tilt angle of the liquid crystal compound can be acquired according to a crystal rotation method.

In this specification, the relationship between angles (for example, “orthogonal”, “parallel”, and “90°”) includes a range of an error acceptable in the technical field to which the present invention belongs. Specifically, the range of an error indicates that an error from a strict angle is less than ±10°, and the error from the strict angle is preferably 5° or less and more preferably 3° or less.

In this specification, “(meth)acrylate” indicates any of acrylate and methacrylate, and “(meth)acryloyl” indicates any of acryloyl and methacryloyl.

As a feature of the present invention, as described above, it was found that desired effects can be obtained by using a liquid crystal display device comprising an optically anisotropic layer that satisfies a predetermined retardation relationship. This optically anisotropic layer functions as a so-called optical compensation layer. Particularly, in the present invention, light leakage during black display can be improved by satisfying a specific retardation relationship. Further, in a case where reduction of the film thickness of an optically anisotropic layer results in deformation of a polarizer or the like while a liquid crystal display device is allowed to stand in a hot and humid environment and the optically anisotropic layer is deformed following the deformation, the optical characteristics (retardation) are unlikely to be changed, and thus occurrence of display unevenness is suppressed. Further, by laminating the optically anisotropic layer and the polarizer in a predetermined order, optical fluctuation of the optically anisotropic layer in a hot and humid environment is suppressed, and degradation of display performance with time can be suppressed even in applications where the use environment is likely to be changed, such as smartphones, tablets, notebook computers, and in-vehicle displays.

Hereinafter, embodiments of the present invention will be described with reference to the accompanying drawings.

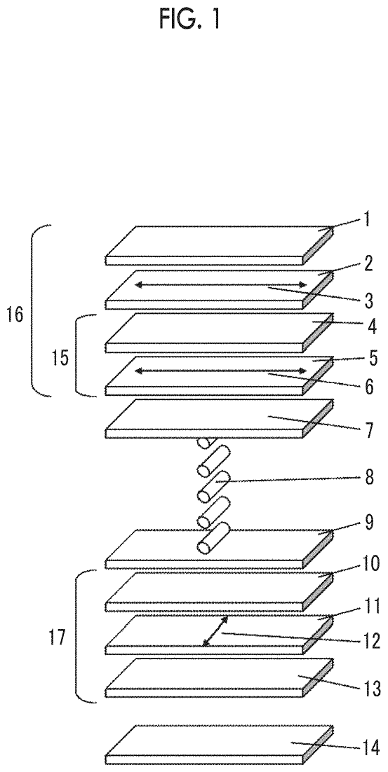

A liquid crystal display device illustrated in FIG. 1 includes a liquid crystal cell (an upper substrate 7 of the liquid crystal cell, a liquid crystal layer 8, and a lower substrate 9 of the liquid crystal cell), a first polarizing plate 16 (a first polarizer protective layer 1, a first polarizer 2, a second optically anisotropic layer 4, and a first optically anisotropic layer 5) that interposes the liquid crystal cell, a second polarizing plate 17 (a liquid crystal cell-side polarizer protective layer 10 of the second polarizing plate, a second polarizer 11, and a second polarizer protective layer 13), and a backlight unit 14 provided on the outside thereof. The liquid crystal cell (7 to 9) includes the upper substrate 7 of the liquid crystal cell, the lower substrate 9 of the liquid crystal cell, and the liquid crystal layer 8 interposed therebetween.

Further, FIG. 1 is an example of the present embodiment, and the effects of the present invention can be obtained even in a case where the backlight unit is disposed outside the first polarizing plate instead of outside the second polarizing plate.

(Polarizer Protective Layers 1, 10, and 13)

The polarizer protective layers 1, 10 and 13 are provided for protecting the first polarizer 2 and the second polarizer 11.

The kind of the polarizer protective layer is not particularly limited, and examples thereof include films such as cellulose acylate, polycarbonate, polysulfone, polyethersulfone, polyacrylate and polymethacrylate, cyclic polyolefin, polyolefin, polyamide, polystyrene, and polyester. Among these, a cellulose acylate film, a cyclic polyolefin film, a polyacrylate film, or a polymethacrylate film is preferable. Further, commercially available cellulose acetate films (for example, “TD8OU” and “Z-TAC” manufactured by Fujifilm Corporation) can also be used.

The polarizer protective layer may have a form of only one layer or a form in which two or more layers are laminated.

Further, the liquid crystal display device may have a configuration that does not have a polarizer protective layer.

The film thickness of the polarizer protective layer is not particularly limited, but is preferably 80 μm or less, more preferably 40 μm or less, and still more preferably 25 μm or less from the viewpoint of reducing the thickness of the liquid crystal display device. The lower limit thereof is not particularly limited, but is preferably 1 μm or greater from the viewpoint of the mechanical strength.

(Polarizers 2 and 11)

The kind of the first polarizer 2 and the second polarizer 11 is not particularly limited, and known polarizers can be employed.

In the present invention, a commonly used linear polarizer can be used. As the linear polarizer, a coating type polarizer which is available from Optiva Inc., or a polarize: containing a binder and iodine or a dichroic dye is preferable. The iodine and the dichroic dye in a linear polarizer exhibit polarization performance by being aligned in a binder. It is preferable that the iodine and the dichroic dye are aligned along the binder molecule or the dichroic dye is aligned in one direction through self organization similarly to a liquid crystal. Recently, commercially available polarizers are typically prepared by immersing a stretched polymer in a solution of iodine or a dichroic dye in a bathtub and allowing the iodine or the dichroic dye to permeate into the binder.

The film thickness of the first polarizer 2 and the second polarizer 11 is not particularly limited, but is preferably 30 μm or less, more preferably 15 μm or less, and still more preferably 10 μm or less from the viewpoint of reducing the thickness of the liquid crystal display device. The lower limit thereof is not particularly limited, but is preferably 1 μm or greater from the viewpoint of the mechanical strength.

(First Optically Anisotropic Layer 5)

The first optically anisotropic layer 5 is a layer disposed on a surface of the following second optically anisotropic layer 4 opposite to the first polarizer 2, and the first optically anisotropic layer 5 is disposed on a side of the liquid crystal cell at the time of disposition of the first polarizer on the liquid crystal cell described below. Re1 (550) and Rth1 (550) of the first optically anisotropic layer 5 each satisfy Expression (1) and Expression (2).

80 nm≤Re1 (550)≤160 nm Expression (1)

40 nm≤Rth1 (550)≤80 nm Expression (2)

From the viewpoint of further improving the color display and light leakage in an oblique direction of the liquid crystal display device according to the embodiment of the present invention (hereinafter, also simply referred to as “from the viewpoint that the effects of the present invention are further excellent”), Re1 (550) is preferably in a range of 110 to 150 nm, more preferably in a range of 115 to 145 nm, still more preferably in a range of 120 to 140 nm, and particularly preferably in a range of 125 to 140 nm, and Rth1 (550) is preferably in a range of 55 to 75 nm, more preferably in a range of 57 to 73 nm, still more preferably in a range of 60 to 70 nm, and particularly preferably in a range of 62 to 70 nm.

In a case where the relationship of Expression (1) or Expression (2) is not satisfied, the color display and light leakage in an oblique direction of the liquid crystal display device deteriorate.

Further, it is preferable that the in-plane retardation Re1 (450) of the first optically anisotropic layer 5 at a wavelength of 450 nm and the in-plane retardation Re1 (550) of the first optically anisotropic layer 5 at a wavelength of 550 nm satisfy Expression (5).

Re1 (450)/Re1 (550)≤1.00 Expression (5)

In a ease where the retardation value is set to be in the range of Expression (5), the light leakage and a change in tint during black display can be further suppressed. In a case where the value of Re1 (450)/Re1 (550) decreases, a bluish tint during black display can be suppressed. The lower limit of Re1 (450)/Re1 (550) is not particularly limited, but is preferably 0.70 or greater.

The film thickness of the first optically anisotropic layer 5 is not particularly limited, but is preferably 5 or less. From the viewpoint of reducing the thickness of the liquid crystal display device, the thickness thereof is preferably 4 μm or less and more preferably 3 μm or less. Further, the lower limit is not particularly limited, but is preferably 0.1 μm or greater from the viewpoint of suppressing display unevenness.

It is preferable that the first optically anisotropic layer 5 is a positive A plate.

In the present specification, the positive A plate is defined as follows. The positive A plate satisfies the relationship of Expression (A 1) in a case where the refractive index of the in-plane slow axis direction (the direction in which the in-plane refractive index becomes the maximum) of the film is set as nx, the refractive index of the direction orthogonal to the in-plane slow axis in the plane is set as ny, and the refractive index of the thickness direction is set as nz. In the positive A plate, Rth is a positive value.

nx>ny≈nz Expression (A1)

The symbol “≈” includes not only a case where both are completely the same but also a case where both are substantially the same. The expression “substantially the same” means that “ny≈nz” includes a case where (ny−nz)×d (where d represents the film thickness of the film) is in a range of −10 to 10 nm and preferably in a range of −5 to 5 nm.

It is preferable that the first optically anisotropic layer 5 is a layer formed using a liquid crystal compound. The kind of the liquid crystal compound is not particularly limited, but can be classified into a rod-like type (rod-like liquid crystal compound) and a disk-like type (discotic liquid crystal compound) based on the shape thereof. Further, a low-molecular-weight type and a polymer type are present respectively. A polymer typically indicates a polymer having a degree of polymerization of 100 or greater (Polymer Physics and Phase Transition Dynamics, written by Masao Doi, p. 2, lwanami Shoten, Publishers., 1992). In the present invention, any liquid crystal compound can be used, but a rod-like liquid crystal compound is preferable. Two or more rod-like liquid crystal compounds, two or more discotic liquid crystal compounds, or a mixture of a rod-like liquid crystal compound and a discotic liquid crystal compound may be used.

As the rod-like liquid crystal compound, for example, those described in claim 1 of JP1999-513019A (JP-1-H11-513019A) and paragraphs [0026] to [0098] of JP2005-289980A can be preferably used. Further, as the discotic liquid crystal compound, for example, those described in paragraphs [0020] to [0067] of JP2007-108732A and paragraphs [0013] to [0108] of JP2010-244038A can be preferably used, and the present invention is not limited thereto.

From the viewpoint that a change in temperature and a change in humidity can be reduced, it is more preferable that the first optically anisotropic layer 5 is formed using a liquid crystal compound containing a polymerizable group (polymerizable liquid crystal compound). The liquid crystal compound may be a mixture of two or more kinds thereof. In this case, it is preferable that at least one liquid crystal compound contains two or more polymerizable groups.

That is, it is preferable that the first optically anisotropic layer 5 is a layer in which a liquid crystal compound containing a polymerizable group (preferably a rod-like liquid crystal compound) is fixed by polymerization or the like. In this case, the liquid crystallinity is not necessarily exhibited after the layer is formed.

The kind of the polymerizable group contained in the liquid crystal compound is not particularly limited, and a functional group capable of performing an addition polymerization reaction is preferable, and a polymerizable ethylenically unsaturated group or a ring polymerizable group is preferable. More specifically, a (meth)acryloyl group, a vinyl group, a styryl group, or an ally group is preferable, and a (meth)acryloyl group is more preferable.

It is preferable that the first optically anisotropic layer is a layer in which the rod-like liquid crystal compound is fixed in a state of being aligned in a direction horizontal to the substrate surface (layer surface).

It is preferable that the composition containing a polymerizable liquid crystal. compound used for forming the first optically anisotropic layer (polymerizable liquid crystal composition) contains a polymerization initiator.

Examples of the polymerization initiator to be used include a thermal polymerization initiator and a photopolymerization initiator. Examples of the photoradical polymerization initiator include a benzoin compound, a benzophenone compound, an alkylphenone compound, an acylsulfoxide compound, a triazine compound, an oxime ester-based compound, and onium salts.

As necessary, the polymerization initiator can be used in combination with a sensitizer or a chain transfer agent.

In the present invention, an oxime ester-based photopolymerization initiator is preferred from the viewpoint of improving the durability of the polarizer. That is, it is preferable that the first optically anisotropic layer is a layer which the alignment state of the polymerizable liquid crystal compound is fixed using an oxime ester-based photopolymerization initiator.

In the present invention, the slow axis 6 of the first optically anisotropic layer 5 and the absorption axis 3 of the first polarizer 2 are parallel to each other at the time of observation in the normal direction of the surface of the first polarizer protective layer 1 (at the time of observation downward in FIG. 1).

(Second Optically Anisotropic Layer 4)

The second optically anisotropic layer 4 is a layer disposed between the first polarizer 2 and the first optically anisotropic layer 5, and Re2 (550) and Rth2 (550) of the second optically anisotropic layer 4 satisfy Expression (3) and Expression (4).

0 nm≤Re2 (550)≤10 nm Expression (3)

−150 nm≤Rth2 (550)≤−70 nm Expression (4)

From the viewpoint that the effects of the present invention are further excellent, Re2 (550) is preferably in a range of 0 to 5 nm and more preferably in a range of 0 to 3 nm, and Rth2 (550) is preferably in a range of −130 to −80 nm, more preferably in a range of −125 to −85 nm, still more preferably in a range of −120 to −90 nm, and particularly preferably in a range of −120 to −95 nm.

The slow axis direction of the second optically anisotropic layer is not particularly limited.

In a case where the relationship of Expression (3) or Expression (4) is not satisfied, the color display and light leakage in an oblique direction of the liquid crystal display device deteriorate.

Further, it is preferable that the retardation Rth2 (450) of the second optically anisotropic layer 4 at a wavelength of 450 nm in the thickness direction and the retardation Rth2 (550) of the second optically anisotropic layer 5 at a wavelength of 550 nm in the thickness direction satisfy Expression (6).

Rth2 (450)/Rth2 (550)≤1.00 Expression (6)

In a case where the retardation value is set to be in the above-described range, the light leakage and a change in tint during black display can be further suppressed.

Further, it is preferable that the second optically anisotropic layer 4 satisfies Expression (7).

Rth2 (450)/Rth2 (550)≤0.82 Expression (7)

In a case where the value of Rth2 (450)/Rth2 (550) decreases, a reddish tint during black display can be suppressed so that a change in hue due to a change in the viewing direction can be suppressed. The lower limit of Rth2 (450)/Rth2 (550) is not particularly limited, but is preferably 0.70 or greater.

The film thickness of the second optically anisotropic layer 4 is not particularly limited, but is preferably 5 μm or less. From the viewpoint of reducing the thickness of the liquid crystal display device, the thickness thereof is preferably 4 μm or less and more preferably 3 μm or less. Further, the lower limit is not particularly limited, but is preferably 0.1 μm or greater from the viewpoint of suppressing display unevenness.

It is preferable that the second optically anisotropic layer 4 is a positive C plate.

In the present specification, the positive C plate is defined as follows. The positive C plate satisfies the relationship of Expression (A2) in a case where the refractive index of the in-plane slow axis direction (the direction in which the in-plane refractive index becomes the maximum) of the film is set as nx, the refractive index of the direction orthogonal to the in-plane slow axis in the plane is set as ny, and the refractive index of the thickness direction is set as nz. In the positive C plate, Rth is a positive value.

nx≈ny<nz Expression (A2)

The symbol “≈” includes not only a case where both are completely the same but also a case where both are substantially the same. The expression “substantially the same” means that “nx≈ny” includes a case where (nx−ny)×d (where d represents the film thickness of the film) is in a range of −10 to 10 nm and preferably in a range of −5 to 5 nm.

It is preferable that the second optically anisotropic layer 4 is a layer formed using a liquid crystal compound. The kind of the liquid crystal compound is not particularly limited, and examples thereof include the liquid crystal compounds exemplified in the section of the first optically anisotropic layer 5 described above. From the viewpoint that the effects of the present invention are further excellent, it is preferable that the liquid crystal compound is a rod-like liquid crystal compound.

Further, it is more preferable that the second optically anisotropic layer 4 is formed using a rod-like liquid crystal compound containing a polymerizable group similarly to the first optically anisotropic layer 5 described above.

It is preferable that the second optically anisotropic layer is preferably a layer in which the rod-like liquid crystal compound is fixed in a state of being aligned in a direction perpendicular to the substrate surface (layer surface).

It is preferable that the polymerizable liquid crystal composition used for forming the second optically anisotropic layer contains a polymerization initiator. As the polymerization initiator to be used, any initiator can be used as in the first optically anisotropic layer. However, in the present invention, from the viewpoint of improving the durability of the polarizer, an oxime ester-based photopolymerization initiator is preferable. That is, it is preferable that the second optically anisotropic layer is a layer in which the alignment state of the polymerizable liquid crystal compound is fixed using an oxime ester-based photopolymerization initiator.

In the present invention, it is necessary that the film thickness of the first optically anisotropic layer and the second optically anisotropic layer in the laminated form is 8 μm or less.

The film thickness in the laminated form indicates the total film thickness including the layer interposed between the first optically anisotropic layer and the second optically anisotropic layer. For example, in a case where the first optically anisotropic layer and the second optically anisotropic layer are bonded to each other with a pressure sensitive adhesive or the like, the film thickness thereof is 8 μm or less, including the film thickness of the pressure sensitive adhesive. That is, the film thickness in the laminated form indicates the total film thickness of the film thickness of the first optically anisotropic layer, the film thickness of the second optically anisotropic layer, and the film thickness of the layer interposed between the first optically anisotropic layer and the second optically anisotropic layer. The unevenness caused by warpage of the panel can be suppressed by reducing the thickness of the optically anisotropic layer.

The film thickness in the laminated form is more preferably 5 μm or less.

The lower limit of the film thickness in the laminated form is not particularly limited, but is preferably 0.2 μm or greater from the viewpoint of suppressing the display unevenness.

It is preferable that the first optically anisotropic layer and the second optically anisotropic layer are adjacent to each other without using an adhesive or a pressure sensitive adhesive. The term “adjacent” does not mean that layers separately prepared are bonded to each other but that one layer is directly formed on one surface of the other layer. As the method of directly forming a layer, for example, in a case where the second optically anisotropic layer is formed on the first optically anisotropic layer, the second optically anisotropic layer may be formed after a surface treatment (for example, a glow discharge treatment, a corona discharge treatment, or an ultraviolet (UV) treatment) is performed on the first optically anisotropic layer and an easy-adhesion layer or the like is formed, or the second optically anisotropic layer may be formed through an alignment. film. Further, the first optically anisotropic layer may be formed on the second optically anisotropic layer.

From the viewpoint of simplifying the production process, it is preferable that the first optically anisotropic layer and the second optically anisotropic layer are in contact with each other without using an easy-adhesion layer or an alignment film. Specifically, it is preferable that the second optically anisotropic layer is formed after the surface treatment is performed on the first optically anisotropic layer.

It is preferable that the second optically anisotropic layer is a layer formed sing a liquid crystal composition which contains at least a liquid crystal compound and a compound represented by Formula (I). By using the compound represented by the formula (I), the second optically anisotropic layer can be directly formed on the surface-treated first optically anisotropic layer.

(Z)ₙ-L-(Q)ₘ Formula (I)

Here, in Formula (I), Z represents a substituent containing a polymerizable group, n represents an integer of 0 to 4, and in a case where n represents an integer of 2 to 4, two or more of Z's may be the same as or different from each other.

Further, Q represents a substituent containing at least one boron atom, m represents 1 or 2. and in a case where m represents 2, two Q's may be the same as or different from each other.

L represents an (n+m)-valent linking group. Here, in a case where n represents 0 and m represents 1, L represents a hydrogen atom, a substituted or unsubstituted alkyl group, a substituted or unsubstituted alkenyl group, a substituted or unsubstituted alkynyl group, a substituted or unsubstituted aryl group, or a substituted or unsubstituted heteroaryl group.

In Formula (I), examples of the substituent containing a polymerizable group represented by Z include a substituent containing a (meth)acrylate group, a styryl group, a vinyl ketone group, a butadiene group, a vinyl ether group, an oxiranyl group, an aziridinyl group, or an oxetane group.

Among these, a substituent containing a (meth)acrylate group, a styryl group, an oxiranyl group, or an oxetane group is preferable, and a substituent containing a (meth)acrylate group or a styryl group is more preferable.

In particular, as the substituent containing a (meth)acrylate group, a group having an ethylenically unsaturated double bond represented by Formula (V) is preferable.

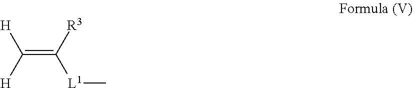

In Formula (V), R³ represents a hydrogen atom or a methyl group and preferably a hydrogen atom.

In Formula (V), L¹ represents a single bond or a divalent linking group selected from the group consisting of O—, —CO—, —NH—, —CO—NH—, —COO—, —O—COO—, an alkylene group, an arylene group, a divalent heterocyclic group, and a combination thereof, preferably a single bond, —CO—NH—, or —COO—, and more preferably a single bond or —CO—NH—.

In Formula (I), n represents an integer of 0 to 4, preferably 0 or 1, and more preferably 1.

Further, m represents 1 or 2 and preferably 1.

Further, L as a divalent linking group may represent a single bond or a divalent linking group selected from —O—, —CO—, —NH—, —CO—NH—, —COO—, —O—COO—, an alkylene group, air arylene group, a heteroarylene group, and a combination thereof. Among these, it is more preferable that L represents a substituted or unsubstituted arylene group.

Further, in the alkyl group, the alkenyl group, the alkynyl group, the aryl group, and the heteroaryl group represented by L, R¹ and R² in Formula (VI) have the same definition, and the preferable ranges thereof are also the same as described above.

Examples of the substituents contained in these groups include the substituents described in paragraph [0046] of JP2013-054201A.

In Formula (I), Q represents a substituent containing at least one boron atom and preferably a group that can be adsorbed on the first optically anisotropic layer and bonded thereto. For example, in a case where the first optically anisotropic layer contains a hydroxyl group or a carboxyl group on the surface due to the surface treatment or the like, a group that can be bonded to the hydroxyl group or the carboxyl group of the first optically anisotropic layer is preferable.

Further, the “group that can be adsorbed on the first optically anisotropic layer and bonded thereto” indicates a group that can interact with the structure of the material constituting the first optically anisotropic layer so as to be chemically adsorbed on the first optically anisotropic layer.

Examples of the substituent containing at least one boron atom include a substituent represented by Formula (VI).

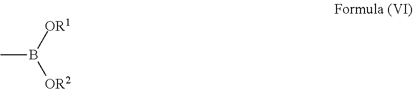

In Formula (VI), R¹ and R² each independently represent a hydrogen atom, a substituted or unsubstituted aliphatic hydrocarbon group, a substituted or unsubstituted aryl group, or a substituted or unsubstituted heteroaryl group.

Further, in R¹ and R² in Formula (VI), R¹ and R² may be linked to each other to form a linking group consisting of an alkylene group, an aryl group, or a combination thereof.

In Formula (VI), the substituted or unsubstituted aliphatic hydrocarbon groups respectively represented by R¹ and R² include a substituted or unsubstituted alkyl group, a substituted or unsubstituted alkenyl group and a substituted or unsubstituted alkynyl group.

Specific examples of the alkyl group include a linear, branched, or cyclic alkyle group such as a methyl group, an ethyl group, a propyl group, a butyl group, a pentyl group, a hexyl group, a heptyl group, an octyl group, a nonyl group, a decyl group, an undecyl group, a dodecyl group, a tridecyl group, a hcxadecyl group, an octadecyl group, an eicosyl group, an isopropyl group, an isobutyl group, a sec-butyl group, a tert-butyl group, an isopentyl group, a neopentyl group, a 1-methylbutyl group, an isohexyl group, a 2-methylhexyl group, a cyclopentyl group, a cyclohexyl group, a 1-adamantyl group, or a 2-norbornyl group.

Specific examples of the alkenyl group include a linear, branched, or cyclic alkenyl group such as a vinyl group, a 1-propenyl group, a 1-butenyl group, a 1-methyl-1-propenyl group, a 1-cyclopentenyl group, or a 1-cyclohexenyl group.

Specific examples of the alkynyl group include an ethynyl group, a 1-propynyl group, a 1-butynyl group, and a 1-octynyl group.

Specific examples of the aryl group include those in which one to four benzene rings form a fused ring and those in which a benzene ring and an unsaturated five-membered ring form a fused ring, and specific examples thereof include a phenyl group, a naphthyl group, an anthryl group, a phenanthryl group, an indenyl group, an acenabutenyl group, a fluorenyl group, and a pyrenyl group.

In Formula (VI), examples of the substituted or unsubstituted heteroaryl groups respectively represented by R¹ and R² include those obtained by removing one hydrogen atom on a heteroaromatic ring that contains one or more heteroatoms selected from the group consisting of a nitrogen atom, an oxygen atom, and a sulfur atom to obtain a heteroaryl group.

Specific examples of the heteroaromatic ring containing one or more heteroatoms selected from the group consisting of a nitrogen atom, an oxygen atom, and a sulfur atom include pyrrole, furan, thiophene, pyrazole, imidazole, triazole, oxazole, isoxazole, oxadiazole, thiazole, thiadiazole, indole, carbazole, benzofuran, dibenzofuran, thianaphthene, dibenzothiophene, indazole benzimidazole, anthranil, benzisoxazole, benzoxazole, benzothiazole, purine, pyridine, pyridazine, pyrimidine, pyrazine, triazine, quinoline, acridine, isoquinoline, phthalazine, quinazoline, quinoxaline, naphthyridine, phenanthroline, and pteridine.

It is preferable that R¹ and R² in Formula (VI) represent a hydrogen atom.

Further, R¹ and R² in Formula (VI) and L in Formula (I) may be further substituted with one or more substituents where possible. One or more of these hydrocarbon groups may be substituted with optional substituent. Examples of the substituent include a monovalent non-metallic atomic group excluding hydrogen.

The molecular weight of the compound represented by Formula (I) is preferably in a range of 120 to 1200 and more preferably in a range of 180 to 800.

Specific examples of the compound represented by Formula (I) include the compounds exemplified as the specific examples described in paragraphs [0035] to [0040] of JP2007-219193A, and the contents are incorporated herein. It goes without saying that the present invention is not limited to these specific examples.

(First Polarizing Plate)

The first polarizing plate has at least the first optically anisotropic layer, the second optically anisotropic layer, and the first polarizer described above.

The absorption axis of the first polarizer and the slow axis of the first optically anisotropic layer are laminated so as to be parallel to each other.

As described above, a polarizer protective layer may be provided on the surface of the first polarizer opposite to the optically anisotropic layer, a cured resin layer may be disposed thereon, or another member of the liquid crystal display device may be directly attached thereonto.

Further, the first polarizing plate may include the above-described polarizer protective layer or may include an adhesive layer described below.

Further, the absorption axis of the first polarizer is orthogonal to the slow axis of the liquid crystal layer during black display which is controlled in alignment in the liquid crystal cell described below.

An adhesive can be used for laminating the first polarizer, the polarizer protective layer, and the optically anisotropic layer. The thickness of the adhesive layer between the first polarizer and the polarizer protective layers provided on both surfaces of the first polarizer or the thickness of the adhesive layer between the optically anisotropic layers is preferably approximately 0.01 to 20 μm, more preferably in a range of 0.01 to 10 μm, and still more preferably in a range of 0.05 to 5 μm. In a case where the thickness of the adhesive layer is in the above-described range, floating or peeling does not occur between the polarizer protective layers or the optically anisotropic layer and the first polarizer to be laminated, and an adhesive force that does not cause any practical problem can be obtained.

As one preferable adhesive, a water-based adhesive, that is, an adhesive in which an adhesive component is dissolved or dispersed in water can be exemplified, and an adhesive formed of a polyvinyl alcohol-based resin aqueous solution is preferably used. That is, it is preferable to use a polyvinyl alcohol-based adhesive.

In an adhesive formed of a polyvinyl alcohol-based resin aqueous solution, examples of the polyvinyl alcohol-based resin include a. vinyl alcohol homopolymer obtained by performing a saponification treatment on polyvinyl acetate, which is a homopolymer of vinyl acetate, a vinyl alcohol-based copolymer obtained by performing a saponification treatment on a copolymer of vinyl acetate and another monomer which can be copolymerized with this vinyl acetate, and a modified polyvinyl alcohol-based copolymer in which a hydroxyl group thereof is partially modified.

A crosslinking agent may be added to the adhesive, and examples of the crosslinking agent include a polyhydric aldehyde, a water-soluble epoxy compound, a melamine-based compound, a zirconia compound, a zinc compound, and a glyoxylate. In a case where an aqueous adhesive is used, the film thickness of the adhesive layer obtained therefrom is typically 1 μm or less.

As one preferable adhesive, a curable adhesive composition cured by being irradiated with active energy rays or being heated is exemplified. Examples of the curable adhesive composition include a curable adhesive composition containing a cationic polymerizable compound, and a curable adhesive composition containing a radically polymerizable compound.

Examples of the cationic polymerizable compound include a compound containing an epoxy group or an oxetanyl group. The epoxy compound is not particularly limited as long as the compound contains at least two epoxy groups in a molecule, and examples thereof include compounds described in detail in JP2004-245925A.

The radically polymerizable compound is not particularly limited as long as the radically polymerizable compound has an unsaturated double bond such as a (meth)acryloyl group or a vinyl group, and examples thereof include a monofunctional radically polymerizable compound, a polyfunctional radically polymerizable compound containing two or more polymerizable groups in a molecule, (meth)acrylate containing a hydroxyl group, acrylamide containing a hydroxyl group, and acryloyl morpholine containing a hydroxyl group. Further, these compounds may be used alone or in combination. For example, compounds described in detail in JP2015-011094A can be used. Further, a radically polymerizable compound and a cationic polymerizable compound can be used in combination.

In a case where a curable adhesive is used, the film is attached using a laminating roll, dried as necessary, and irradiated or heated with active energy rays so that the curable adhesive is cured. Although the light source of the active energy ray is not particularly limited, active energy rays having a light emission distribution at a wavelength of 400 nm or less are preferable, and specific preferred examples thereof include a low-pressure mercury lamp, a medium-pressure mercury lamp, a high-pressure mercury lamp, an ultrahigh-pressure mercury lamp, a chemical lamp, a black light lamp, a microwave-excited mercury lamp, and a metal halide lamp.

In addition, at the time of attachment of the polarizer protective layer or the optically anisotropic layer and the first polarizer with an adhesive, a surface treatment (for example, a glow discharge treatment, a corona discharge treatment, or an ultraviolet (UV) treatment) may be performed on the surface of the polarizer protective layer or the optically anisotropic layer opposite to the first polarizer or an easy-adhesion layer or the like may be formed thereon for the purpose of improving the adhesive strength and improving the wettability of the adhesive to the surface. The materials and the forming methods of the easy-adhesion layer described in JP2007-127893A and JP2007-127893A can be used.

The film thickness of the first polarizing plate having each of the above-described configurations is preferably 100 μm or less, more preferably 70 μm or less, and still more preferably 50 μm or less. The lower limit thereof is not particularly limited, but is preferably 10 μm or greater from the viewpoint of the mechanical strength.

For example, according to the embodiment of FIG. 1, the film thickness of the first polarizer plate 16 indicates the total film thickness of the film thickness of the first polarizer protective layer 1, the film thickness of the first polarizer 2, the film thickness of the second optically anisotropic layer 4, and the film thickness of the first optically anisotropic layer 5. In a case where the first polarizing plate 16 includes layers other than the above-described layers (for example, an alignment film described below), the film thickness of the first polarizer plate 16 indicates the film thickness of the entire first polarizing plate 16 including those layers.

Other layers indicate layers (for example, a pressure sensitive adhesive layer and an alignment film) disposed between the first polarizer protective layer and the first polarizer, between the first polarizer and the second optically anisotropic layer, or between the second optically anisotropic layer and the first optically anisotropic layer. Therefore, layers (for example, a pressure sensitive adhesive layer and a hard coat layer) disposed outside the first polarizer protective layer (a side opposite to the first polarizer side) and outside the first optically anisotropic layer (a side opposite to the second optically anisotropic layer side) are not included in the film thickness of the polarizing plate.

The optically anisotropic layer may have an alignment film at the interface (the surface thereof).

The alignment film typically contains a polymer as a main component. The polymer material for the alignment film is described in multiple documents, and multiple commercially available products can be obtained. As the polymer material for an alignment film to be used, polyvinyl alcohol or polyimide and derivatives thereof are preferable. Modified or unmodified polyvinyl alcohol is particularly preferable. The alignment film which can be used in the present invention can refer to the modified polyvinyl alcohols described from the 24th line on page 43 to the 8th line on page 49 of WO01/88574A1 and paragraphs [0071] to [0095] of JP3907735A. Further, a known rubbing treatment is usually applied to the alignment film.

The thickness of the alignment film is preferably thin, but the alignment film is required to have a certain degree of thickness in terms of providing alignment ability for forming an optically anisotropic layer and alleviating the surface unevenness of the first polarizer to form an optically anisotropic layer with a uniform film thickness. Specifically, the thickness of the alignment film is preferably in a range of 0.01 to 10 μm, more preferably in a range of 0.01 to 1 μm, and still more preferably in a range of 0.01 to 0.5 μm.

In the present invention, it is also preferable that a photo-alignment film is used. Although the photo-alignment film is not particularly limited, those described in paragraphs [0024] to [0043] of WO2005 /096041 and LPP-JP265CP (trade name, manufactured by Rolic Technologies Ltd.) can be used.

(Liquid Crystal Cells 7 to 9)

The liquid crystal cells 7 to 9 are IPS mode or FFS mode liquid crystal cells of a lateral electric field system. More specifically, the liquid crystal cell includes a pair of substrates disposed to oppose each other, at least one of which has an electrode, and a liquid crystal layer disposed between the pair of substrates and having a controlled alignment, an electric field which has a component parallel to the substrate having the electrode is formed by the electrode.

The IPS mode liquid crystal cell is a liquid crystal cell in which a liquid crystal compound (particularly, a rod-like liquid crystal compound) in a liquid crystal layer is substantially horizontally aligned in a plane during non-voltage application and switching is performed by changing the alignment direction of the liquid crystal compound based on the presence or absence of application of a voltage. Specifically, those described in JP2004-36594 1A, JP2004-01273 1A, JP2004-215620A, JP2002-221726A, JP2002-055341A, and JP2003-195333A can be used. In these modes, the liquid crystal compound is aligned substantially parallel during black display, and the liquid crystal compound is aligned parallel to the surface of the liquid crystal layer in a state where no voltage is applied to carry out black display.

The FFS mode is a mode in which liquid crystal molecules are switched so as to be constantly horizontal to the surface of the liquid crystal layer similar to the IPS mode, and the liquid crystal molecules are switched using a lateral electric field in a direction horizontal to the surface of the liquid crystal layer. Typically, the FFS mode has a solid electrode, an interlayer insulating film, and a comb-shaped electrode, and the electric field direction thereof is different from that of the IPS mode.

The liquid crystal layer 8 in the liquid crystal cell contains a liquid crystal compound and typically preferably a rod-like liquid crystal compound. The definition of the rod-like liquid crystal compound is as described above.

In the IPS mode or the FFS mode, the liquid crystal compound in the liquid crystal layer is ideally aligned horizontal to the surface of the liquid crystal layer in both white display and black display, but may be aligned by being tilted at a low tilt angle. Typically, in a case where a glass substrate of a liquid crystal cell is rubbed with a cloth and the liquid crystal layer is aligned, the liquid crystal compound is aligned by being tilted at a low tilt angle with respect to the substrate interface, and the liquid crystal compound is aligned substantially horizontally in a case where the glass substrate is irradiated with ultraviolet (UV) light to align the liquid crystal layer (photo-alignment). In the present invention, a liquid crystal cell including a photo-aligned liquid crystal layer is preferable from the viewpoint of preventing light leakage.

The liquid crystal cell is configured such that two sheets of the upper substrate 7 of the liquid crystal cell and the lower substrate 9 of the liquid crystal cell are disposed so as to interpose a liquid crystal layer, and an electrode (preferably, a transparent electrode) is disposed on at least the surface of one substrate). The electrode is configured such that an electric field parallel to the surface of the substrate can be provided for the liquid crystal layer. The electrode is typically formed of a transparent electrode (for example, an electrode formed of indium tin oxide (ITO)).

Further, the liquid crystal cell may include a color filter layer or a thin film transistor (TFT) layer. The positions of the color filter layer and the TFT layer are not particularly limited, and the color filter layer and the TFT layer may be disposed between the liquid crystal layer and the first polarizing plate (in other words, between the liquid crystal layer and the first optically anisotropic layer) or between the liquid crystal layer and the second polarizing plate (in other words, between the liquid crystal layer and the second polarizer).

(Color Filter)

The color filter is not particularly limited. For example, three filters which are a blue color filter (hereinafter, also referred to as a “BCF”), a green color filter (hereinafter, also referred to as a “GCF”), and a red color filter (hereinafter, also referred to as a “RCF”) may be disposed on the upper substrate of the liquid crystal cell (on the surface of the upper substrate of the liquid crystal cell on the viewing side (upper polarizer side)).

Further, it is preferable that the liquid crystal cell includes three pixel regions where the above-described BCF, GCF, and RCF are disposed.

The BCF, GCF, and RCF respectively correspond to the first color filter, the second color filter, and the third color filter of the liquid crystal display device according to the embodiment of the present invention, Further, the three pixel regions in the liquid crystal cell respectively correspond to a first pixel region, a second pixel region, and a third pixel region included in the liquid crystal cell of the liquid crystal display device according to the embodiment of the present invention.

Further, the BCF is a color filter showing the maximum transmittance in the blue region (at a wavelength of 420 to 490 inn), the GCF is a color filter showing the maximum transmittance in the green region (at a wavelength of 495 to 570 nm), and the RCF is a color filter showing the maximum transmittance in the blue region (at a wavelength of 580 to 700 nm).

In the present specification, the “maximum transmittance” indicates the maximum transmittance in a visible light region (at a wavelength of 400 to 700 nm).

A relationship of λ₁<λ₂<λ₃ is satisfied in a case where a wavelength showing the maximum transmittance of the BCF is set as λ₁ (nm), a wavelength showing the maximum transmittance of the GCF is set as λ₂ (nm), and a wavelength showing the maximum transmittance of the RCF is set as λ₃ (nm).

Further, it is preferable that the retardation Rth (λ₁) of the BCF at a wavelength λ₁ in the thickness direction, the retardation Rth (λ₂) of the GCF at a wavelength X.2 in the thickness direction, and the retardation Rth (λ₃) of the RCF at a wavelength λ₃ in the thickness direction satisfy one or both requirements of Expression (8) and Expression (9).

Rth (λ₂)≤Rth (λ₁) Expression (8)

Rth (λ₂)≤Rth (λ₃) Expression (9)

The Rth of the color filter is not particularly limited in the present invention, but the light leakage during black display can be suppressed and the tint can be adjusted by changing the Rth of each color filter.

Examples of the method of adjusting the Rth of a color filter include a method of changing the thickness of the color filter. Further, the Rth of a color filter can be adjusted by adding a retardation enhancer or a retardation reducing agent into the color filter.

Examples of the retardation enhancer include a compound represented by Formula (X) and a compound similar thereto.

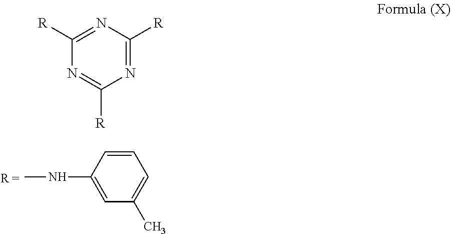

Examples of the retardation reducing agent include a compound represented by Formula (XI).

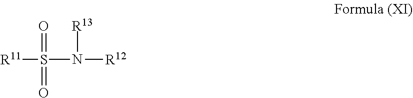

In Formula (XI), R¹¹ represents an alkyl group or an aryl group, and R¹² and R¹³ each independently represent a hydrogen atom, an alkyl group, or an aryl group. Further, the total number of carbon atoms of R¹¹, R¹², and R¹³ is preferably 10 or greater. R¹¹, R¹², and R¹³ may have a substituent. As the substituent, a fluorine atom, an alkyl group, an aryl group, an alkoxy group, a sulfone group, or a sulfonamide group is preferable, and an alkyl group, an aryl group, an alkoxy group, a sulfone group, or a sulfonamide group is more preferable.

Further, the alkyl group may be linear, branched, or cyclic. The number of carbon atoms in the alkyl group is preferably in a range of 1 to 25, more preferably in a range of 6 to 25, and still more preferably in a range of 6 to 20. Examples of the alkyl group include a methyl group, an ethyl group, a propyl group, an isopropyl group, a butyl group, an isobutyl group, a t-butyl group, an amyl group, an isoamyl group, a t-amyl group, a hexyl group, a cyclohexyl group, a heptyl group, an octyl group, a bicyclooctyl group, a nonyl group, an adamantyl group, a decyl group, a t-octyl group, an undecyl group, a dodecyl group, a tridecyl group, a tetradecyl group, a pentadecyl group, a hexadecyl group, a heptadecyl group, an octadecyl group, a nonadecyl group, and a didecyl group.

The carbon number of the aryl group is preferably in a range of 6 to 30, and more preferably in a range of 6 to 24. As the aryl group, a phenyl group, a biphenyl group, a terphenyl group, a naphthyl group, a binaphthyl group, or a triphenylphenyl group is preferable.

The method for preparing the color filters (the BCF, the GCF, and the RCF) is not particularly limited, and examples thereof include a colored resist method of applying a colored photosensitive resin composition using a spin coater or the like and performing a photolithography step to carry out patterning and a lamination method. In a formation method including a coating step such as the colored resist method, color filters with different film thicknesses can be formed by adjusting the coating amount. Further, in the lamination method, color filters with different film thicknesses can be formed by using transfer materials with different film thicknesses.

In addition, a black matrix may be disposed between the color filters as necessary. The method for preparing the black matrix is not particularly limited, and known methods can be used.

The BCF, the GCF, and the RCF included in the liquid crystal display device have been mainly described above in detail, but the present invention is not limited to this embodiment, and the BCF, the GCF, and the RCF may be different color filters.

(Second Polarizing Plate)

The second polarizing plate 17 is a polarizing plate disposed on a side of the liquid crystal display device opposite to the first polarizing plate.

The configuration of the second polarizing plate 17 is not particularly limited as long as the second polarizing plate includes at least the second polarizer. As the polarizer, the polarizer exemplified in the section of the first polarizer 2 described above can be used, and the suitable range of the film thickness thereof is the same as described above.

The absorption axis of the first polarizer in the first polarizing plate is orthogonal to the absorption axis of the second polarizer in the second polarizing plate.

Further, the slow axis of the liquid crystal layer having a controlled alignment in the liquid crystal cell during black display is parallel to the absorption axis of the second polarizer in the second polarizing plate 17.

Further, at the time of observation in the normal direction of the surface of the first polarizing plate 16, it is preferable that the angle between the absorption axis 3 of the first polarizer 2 in the first polarizing plate 16 and the absorption axis 12 of the second polarizer 11 in the second polarizing plate 17 is a right angle.

The film thickness of the second polarizing plate 17 is not particularly limited, but is preferably 100 μm or less, more preferably 60 μm or less, still more preferably 40 μm or less, and even still more preferably 20 μm or less from the viewpoint of reducing the thickness of the liquid crystal display device. The lower limit thereof is not particularly limited, but is preferably 10 μm or greater from the viewpoint of the mechanical strength.

The second polarizing plate 17 may include a polarizer protective layer and the like in addition to the polarizer. Particularly, in a case where the polarizer protective layer is provided on a side of the liquid crystal cell, a film having a small retardation is preferable.

The in-plane retardation Re of the polarizer protective layer on a side of the liquid crystal cell is preferably in a range of 0 to 10 nm, more preferably in a range of 0 to 5 nm, and still more preferably in a range of 0 to 2 nm.

Further, the slow axis direction of the polarizer protective layer on a side of the liquid crystal cell is not particularly limited.

The retardation Rth in the thickness direction is preferably in a range of −10 to 10 nm, more preferably in a range of −5 to 5 nm, and still more preferably in a range of −2 to 2 nm.

### EXAMPLES

Hereinafter, the present invention will be described in more detail based on the following examples. Materials, used amounts, ratios, treatment contents, treatment procedures, and the like described in the following examples can be appropriately changed without departing from the gist of the present invention. Therefore, the scope of the present invention is not limited to the following specific examples.

### Example 1

<Preparation of Protective Film 1>

The following composition was put into a mixing tank and stirred to dissolve each component, thereby preparing a core layer cellulose acylate dope 1.

Cellulose acetate having acetyl substitution degree of 2.88: 100 parts by mass

Ester oligomer (compound 1-1): 10 parts by mass

Durability enhancer (compound 1-2): 4 parts by mass

UV absorbing agent (compound 1-3): 3 parts by mass

Methylene chloride (first solvent): 438 parts by mass

Methanol (second solvent): 65 parts by mass

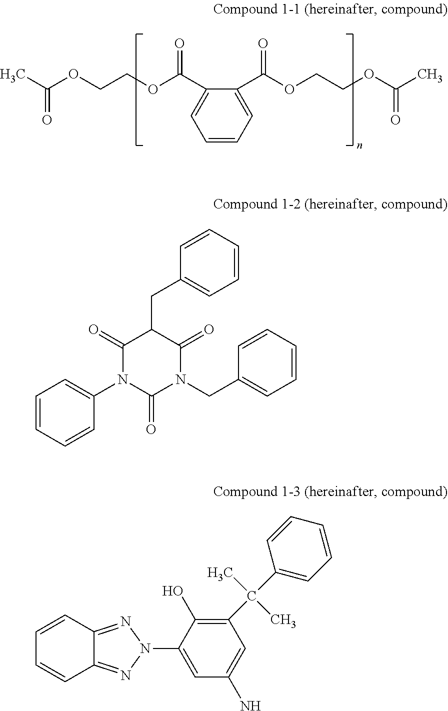

[Preparation of Outer Layer Cellulose Acylate Dope 1]

10 parts by mass of the following matting agent dispersion liquid 1 was added to 190 parts by mass of the above-described core layer cellulose acylate dope, thereby preparing an outer layer cellulose acylate dope 1.

Silica particles with average particle size of 20 nm

(AEROSIL R972, manufactured by Nippon Aerosil Co., Ltd.): 2 parts by mass

Methylene chloride (first solvent): 76 parts by mass

Methanol (second solvent): 11 parts by mass

Core layer cellulose acylate dope 1: 1 parts by mass

[Preparation of Cellulose Acylate Film]

Three layers which were the above-described core layer cellulose acylate dope 1 and the outer layer cellulose acylate dopes 1 provided on both sides of the core layer cellulose acylate dope 1 were simultaneously cast from a casting port onto a drum at 20° C. The film was peeled off from the drum in a state where the solvent content of the film on the drum was approximately 20% by mass, both ends of the obtained film in the width direction were fixed by tenter clips, and the film was dried while being stretched at a stretching ratio of 1.2 times in the lateral direction in a state where the content of the residual solvent in the film was in a range of 3% to 15% by mass. Thereafter, the obtained film was transported to a space between rolls of a heat treatment device to prepare a cellulose acylate film having a thickness of 25 μm, thereby obtaining a polarizer protective film 1.

<Preparation of Hard Coat Layer>

As a coating solution for forming a hard coat layer, a curable composition 1 for a hard coat listed in Table 1 was prepared.

TABLE 1

| | Monomer | | | | UV initiating agent | | |
|---|---|---|---|---|---|---|---|
| | | | | Total addition | | Addition | |
| | | | Monomer | amount | | amount | |
| | | | 1/monomer | [part by | | [part by | |
| | Monomer 1 | Monomer 2 | 2 | mass] | Type | mass] | Solvent |
| Hard | Pentaerythritol | Pentaerythritol | 3/2 | 53.5 | UV initiating | 1.5 | Ethyl |
| coat 1 | triacrylate | tetraaclylate | | | agent 1 | | acetate |

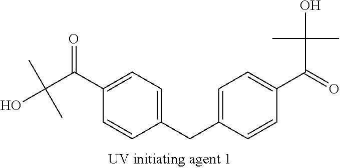 [SMILES: CC(C)(O)C(=O)c1ccc(Cc2ccc(C(=O)C(C)(C)O)cc2)cc1]

The surface of the polarizer protective film 1 prepared in the above-described manner was coated with the curable composition 1 for a hard coat, dried at 100° C. for 60 seconds, irradiation with UV rays at 1.5 kW and an irradiation dose of 300 mJ under a nitrogen condition of 0.1% or less, and cured to prepare a protective film 1 provided with a hard coat layer having a film thickness of 5 μm. Further, the film thickness of the hard coat layer was adjusted by adjusting the coating amount using a slot die according to a die coating method.

<Preparation of Polarizing Plate 1 Provided With Single-Sided Protective Film>

1) Saponification of film

The prepared protective film 1 provided with a hard coat layer was immersed in a 4.5 mol/L sodium hydroxide aqueous solution (saponified solution) whose temperature had been adjusted to 37° C. for 1 minute, and the film was washed with water, immersed in a 0.05 mol/L sulfuric acid aqueous solution for 30 seconds, and then allowed to pass through a water washing bath. Further, the obtained film was repeatedly drained with an air knife three times, retained in a drying zone at 70° C. for 15 seconds after water was dropped, and dried, thereby preparing a saponified protective film 1 provided with a hard coat layer.

2) Preparation of Polarizer

According to the examples of JP2016-148724A, a peripheral speed difference was provided between two pairs of nip rolls, and the film was stretched in the longitudinal direction, preparing a polarizer having a film thickness of 15 μm. The polarizer prepared in the above-described manner was set as a polarizer 1.

3) Attachment

The polarizer 1 obtained in the above-described manner and the saponified protective film 1 provided with a hard coat layer were attached to each other using a 3% PVA. (PVA-117H, manufactured by Kuraray Co., Ltd.) aqueous solution as an adhesive such that the polarization axis was orthogonal to the longitudinal direction of the film according to roll-to-roll processing, thereby preparing a polarizing plate 1 provided with a single-sided protective film (hereinafter, also simply referred to as a polarizing plate 1). At this time, the polarizer 1 and the protective film 1 were attached such that the cellulose acylate film side of the protective film became the polarizer side.

<Preparation of Polarizing Plate 2 Provided With Single-Sided Protective Film>

A polarizing plate 2 (hereinafter, also simply referred to as a polarizing plate 2) was prepared in the same manner except that a hard coat layer was not provided on the surface of the polarizer protective film 1 in the preparation of the polarizing plate 1. Further, each liquid crystal display device was prepared using the polarizing plate 1 on the viewing side and the polarizing plate 2 on the backlight side in the following examples and comparative examples unless otherwise specified.

Preparation of Protective Film 2>

[Preparation of Core Layer Cellulose Acylate Dope 2]

The following composition was put into a mixing tank and stirred to dissolve each component, thereby preparing a core layer cellulose acylate dope 2.

Core Layer Cellulose Acylate Dope 2

Cellulose acetate having acetyl substitution degree of 2.88: 100 parts by mass

Polyester shown below: 12 parts by mass

Durability enhancer described above: 4 parts by mass

Methylene chloride (first solvent): 430 parts by mass

Methanol (second solvent): 64 parts by mass

Polyester (number average molecular weight of 800) (hereinafter, compound

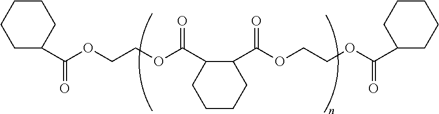

[Preparation of Outer Layer Cellulose Acylate Dope 2]

10 parts by mass of the following matting agent solution was added to 90 parts by mass of the above-described core layer cellulose acylate dope 2, thereby preparing an outer layer cellulose acylate dope 2.

Matting Agent Solution

Silica particles with average particle size of 20 nm

(AEROSIL R972, manufactured by Nippon Aerosil Co., Ltd.): 2 parts by mass

Methylene chloride (first solvent): 76 parts by mass

Methanol (second solvent): 11 parts by mass

Core layer cellulose acylate dope: 1 part by mass

[Preparation of Cellulose Acylate Film 2]

The core layer cellulose acylate dope 2 and the outer layer cellulose acylate dope 2 were filtered through filter paper having an average pore size of 34 μm and a sintered metal filter having an average pore size of 10 μm, and three layers which were the core layer cellulose acylate dope 2 and the outer layer cellulose acylate dopes 2 provided on both sides of the core layer cellulose acylate dope 2 were simultaneously cast from a casting port onto a drum at 20° C. (band casting machine).

Next, the film was peeled off from the drum in a state where the solvent content of the film on the drum was approximately 20% by mass, both ends of the film in the width direction were fixed by tenter clips, and the film was dried while being stretched at a stretching ratio of 1.1 times in the lateral direction.

Thereafter, the obtained film was transported to a space between rolls of a heat treatment device and dried to prepare a cellulose acylate film 2 having a film thickness of 40 μm, thereby obtaining a protective film 2. As a result of measuring the phase difference of the protective film 2, Re was 1 nm and Rth was −5 nm.

<Preparation of First Optically Anisotropic Layer 1>

[Preparation of Composition 1 for Photo-Alignment Film]A material for forming a photo-alignment film described in Example 1 of WO 2016/002722 was prepared and used for producing the liquid crystal film of the present invention.

(Preparation of Composition for Forming an Optically Anisotropic Layer)

A composition for forming an optically anisotropic layer with the following composition was prepared.

Composition 1 for Forming Optically Anisotropic Layer
Liquid crystal compound R1 shown below: 42.00 parts by mass
Liquid crystal compound R2 shown below: 42.00 parts by mass
Polymerizable compound A1 shown below: 16.00 parts by mass
Polymerization initiator S1 shown below: 0.50 parts by mass
Leveling agent P1 shown below: 0.15 parts by mass
HISOLVE MTEM (manufactured by Toho Chemical industry Co., Ltd.): 2.00 parts by mass
NK ESTER A-200 (manufactured by Shin-Nakamura Chemical Co., Ltd.): 1.00 part by mass
Methyl ethyl ketone: 424.8 parts by mass

Further, the group adjacent to the acryloyloxy group in the following liquid crystal compounds R1 and R2 represents a propylene group (a group in which a methyl group has been substituted with an ethylene group), and the liquid crystal compounds R1 and R2 represent a mixture of position isomers with different positions of methyl groups.

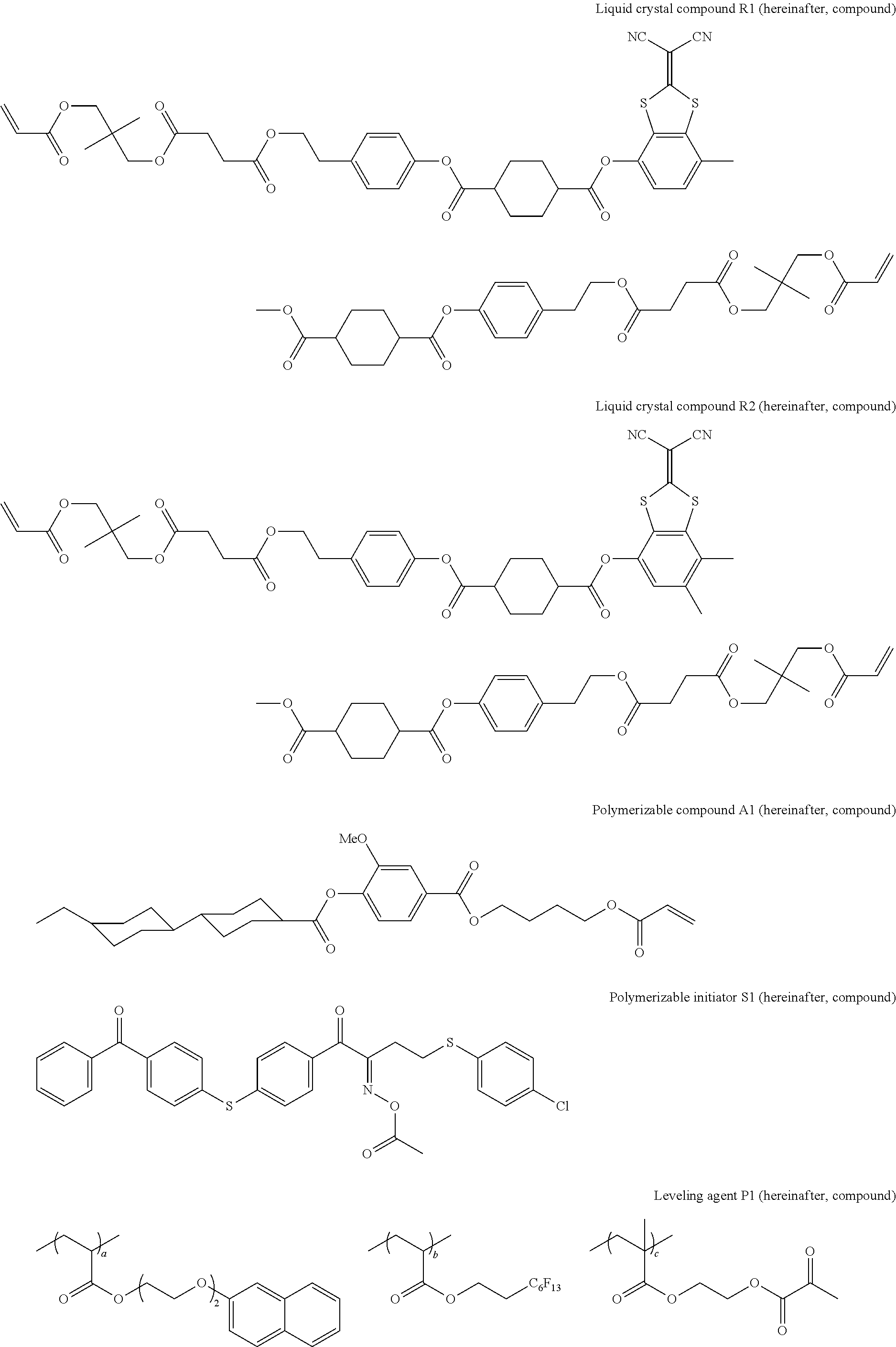

One surface of the prepared protective film 2 was coated with the composition 1 for a photo-alignment film prepared previously using a bar coater. After the film was coated with the composition, the obtained film was dried on a hot plate at 120° C. for 1 minute to remove the solvent, thereby forming a photoisomerizable composition layer with a thickness of 0.3 μm. A photo-alignment film 1 was formed by irradiating the obtained photoisomerizable composition layer with polarized ultraviolet rays (at an irradiation close of 10 mJ/cm²using an ultrahigh-pressure mercury lamp).

Next, the photo-alignment film 1 was coated with the composition 1 for forming an optically anisotropic layer prepared previously to form a composition layer. The formed composition layer was once heated to 110° C. on a hot plate and cooled to 60° C. so that the alignment was stabilized. Thereafter, the temperature of the obtained film was maintained at 60° C. and the alignment was fixed by irradiating the layer with ultraviolet rays (at an irradiation dose of 500 mJ/cm² using an ultrahigh-pressure mercury lamp) in a nitrogen atmosphere (at an oxygen concentration of 100 ppm), thereby preparing a first optically anisotropic layer 1 having a thickness of 2 μm. The in-plane retardation Re1 (550) of the obtained first optically anisotropic layer 1 was 130 nm, and the ratio of Re1 (450)/Re1 (550) was 0.85.

<Preparation of Second Optically Anisotropic Layer 1>

The surface of the first optically anisotropic layer 1 on the coating side was subjected to a corona treatment at a discharge amount of 150 W·min/m², and the surface which had been subjected to a corona treatment was coated with a composition 2 for forming an optically anisotropic layer prepared with the following composition using a wire bar.

Subsequently, the layer was heated at a temperature of 70° C. for 90 seconds for the purpose of drying the solvent in the composition and aging of the alignment of the liquid crystal compound. The composition was irradiated with ultraviolet rays (at an irradiation dose of 300 mJ/cm²) at 40° C. and an oxygen concentration of 0.1% under a nitrogen purge so that the alignment of the liquid crystal compound was fixed, thereby preparing a second optically anisotropic layer 1 on the first optically anisotropic layer 1. The retardation Rth2 (550) of the obtained second optically anisotropic layer 1 in the thickness direction was −100 nm, and the ratio of Rth2 (450)/Rth2 (550) was 0.95.

Composition 2 for Forming Optically Anisotropic Layer

Liquid crystal compound R1: 10.0 parts by mass

Liquid crystal compound R2: 54.0 parts by mass

Liquid crystal compound R3: 28.0 parts by mass

Polymerizable compound A1: 8.0 parts by mass

Compound B1: 1.5 parts by mass

Monomer K1: 8.0 parts by mass

Polymerization initiator S2: 5.0 parts by mass

Polymerization initiator S3: 2.0 parts by mass

Surfactant P2: 0.4 parts by mass

Surfactant P3: 0.5 parts by mass

Acetone: 175.0 parts by mass

Propylene glycol monomethyl ether acetate: 75.0 parts by mass
Liquid crystal compound R3

Mixture of the following liquid crystal compounds (RA), (RB), and (RC) at mass ratio of 83:15:2

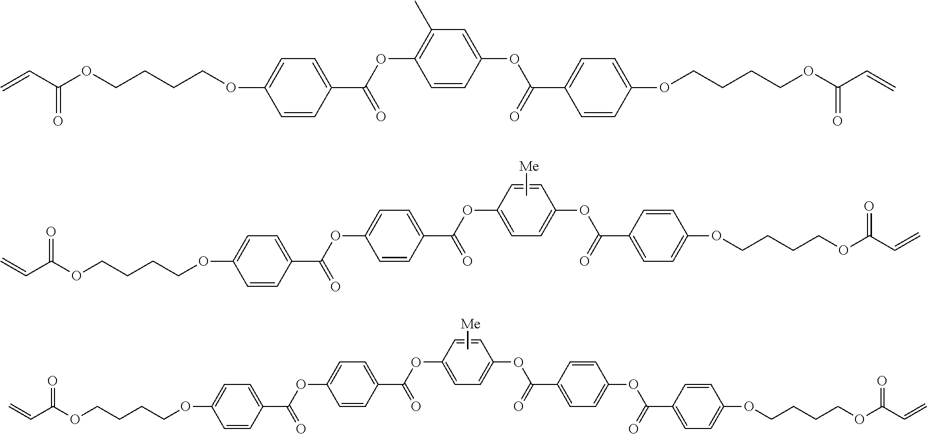

Compound B1 (hereinafter, compound)

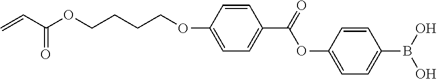 [SMILES: C=CC(=O)OCCCCOc1ccc(C(=O)Oc2ccc(B(O)O)cc2)cc1]

Monomer K1: A-600 (manufactured by Shin-Nakamura Chemical Co., Ltd.)

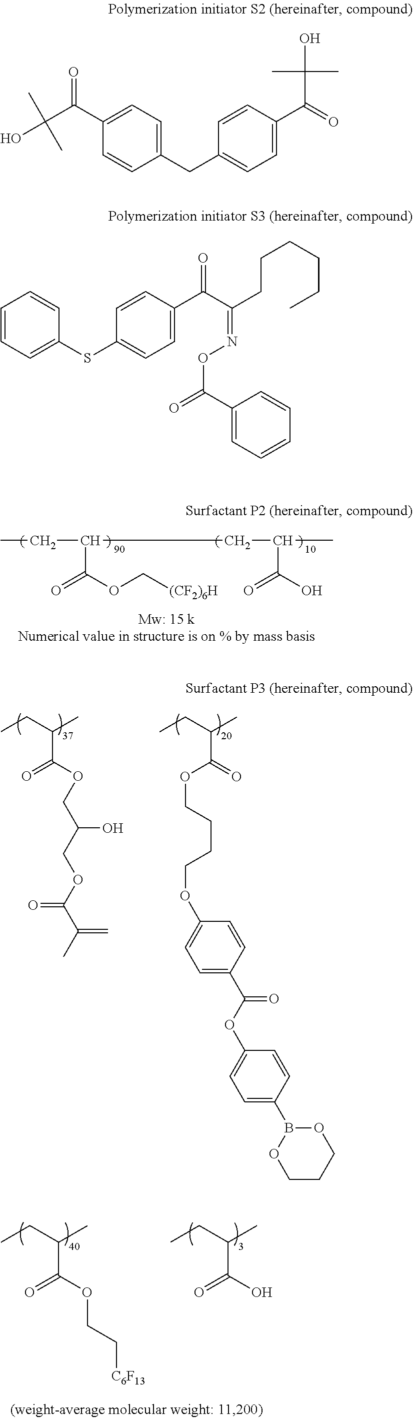

<Preparation of First Polarizing Plate>

The surface of the laminate, on the second optically anisotropic layer 1 side, formed of the first optically anisotropic layer 1 and the second optically anisotropic layer 1 prepared in the above-described manner was attached to the polarizer surface of the prepared polarizer 1 provided with a single-sided protective film using an adhesive such that the absorption axis of the polarizer and the slow axis of the optically anisotropic layer were parallel to each other. The protective film 2 of the first optically anisotropic layer 1 was peeled off to prepare a first polarizing plate of Example 1. A 3% PVA (PVA-117H, manufactured by Kuraray Co., Ltd.) aqueous solution was used as the adhesive. At this time, the polarizer and the optical compensation layer had practically sufficient adhesiveness.

<Preparation of Protective Film 3>

[Preparation of Polymethyl Methacrylate (PMMA) Dope]

The following dope composition was put into a mixing tank and stirred to dissolve each component, thereby preparing a PMMA dope.

PMMA dope

PMMA resin: 100 parts by mass

SUMILIZER GS (manufactured by Sumitomo Chemical Co., Ltd.): 0.1 parts by mass

Dichloromethane: 426 parts by mass

Methanol: 64 parts by mass

[Preparation of PMMA Film]

The above-described PMMA dope was uniformly cast on a stainless steel band (casting support) from a casting die (band casting machine). The film was peeled off in a state where the solvent content in the cast film was approximately 20% by mass, both ends of the film in the width direction were fixed by tenter clips, and the film was dried while being stretched at a stretching ratio of 1.1 times in the lateral direction. Thereafter, the obtained film was transported to a space between rolls of a heat treatment device and dried to prepare a PMMA film having a film thickness of 20 μm, thereby obtaining a protective film 3.

<Preparation of Second Polarizing Plate>

(Preparation of Adhesive Liquid)

The following compounds were mixed at the ratio described below to prepare an adhesive liquid A.

ARONIX M-220 (Toagosei Co., Ltd.): 20 parts by mass

4-Hydroxybutyl acrylate (manufactured by Nippon Kasei Chemical Co., Ltd.): 40 parts by mass

2-Ethylhexyl acrylate (manufactured by Mitsubishi Chemical Corporation): 40 parts by mass

Irgacure907 (manufactured by BASF SE): 1.5 parts by mass

KAYACURE DETX-S (manufactured by Nippon Kayaku Co., Ltd.): 0.5 parts by mass

The surface on which the protective film 3 was attached to the polarizer was subjected to a corona treatment at a discharge amount of 150 W·min/m², and the surface was coated with the adhesive liquid A such that the film thickness thereof was set to 0.5 μm. Thereafter, the adhesive-coated surface was attached to the polarizer surface of the polarizing plate 2 provided with a single-sided protective film, and the surface was irradiated with ultraviolet rays from the protective film 3 on a base material side at an irradiation dose of 300 mJ/cm² at 40° C. in an air atmosphere. Next, the obtained film was dried at 60° C. for 3 minutes, thereby preparing a second polarizing plate of Example 1.

<Preparation of Liquid Crystal Display Device>

Front and rear polarizing plates were peeled off from a commercially available liquid crystal display device (iPad (registered trademark), manufactured by Apple Inc.) (a liquid crystal display device including a liquid crystal cell in an FFS mode), the prepared first polarizing plate including the first optically anisotropic layer and the second optically anisotropic layer was attached to the viewing side and the second polarizing plate was attached to the backlight side using a 20 μm acrylic pressure sensitive adhesive such that respective absorption axes of the polarizers in the polarizing plates were orthogonal to each other and the alignment direction of the liquid crystal in the liquid crystal cell was orthogonal to the absorption axis of the polarizer in the first polarizing plate, thereby preparing a liquid crystal display device of Example 1.

Further, the liquid crystal cell in the liquid crystal display device includes a color filter layer in the substrate on the first polarizing plate side and a TFT layer in the substrate on the second polarizing plate side, Rth (550) of the color filter layer was 10 nm and Rth (550) of the TFT layer was 2 nm. Further, Δn·d of the liquid crystal compound in the liquid crystal cell was 340, and the tilt angle of the liquid crystal compound with respect to the substrate surface was 0.1°.

<Evaluation of Liquid Crystal Display Device>

(Evaluation of Oblique Light Leakage and Tint)

<Oblique Light Leakage>

The black brightness was measured using a measuring device (EZ-Contrast XL88, manufactured by ELDIM Co., Ltd.) during black display of the liquid crystal display device in a dark room. The average value of brightness at azimuth angles of 45°, 135°, 225°, and 315° at a polar angle of 60° was set as light leakage Y and evaluated according to the following evaluation standards. The results are listed in Table 2. In regard to the azimuth angle, the azimuth angle was defined such that the absorption axis direction of the polarizer (first polarizer) on the viewing side was 0° (and 180°), and the absorption axis direction of the polarizer (second polarizer) on the backlight side was 90° (and 270°).

A: Y<0.6 (cd/m²)

B: 0.6 (cd/m²)≤Y<0.8 (cd/m²)

C: 0.8 (cd/m²)≤Y

<Oblique Tint>

The chromaticity was measured using a measuring device (EZ-Contrast XL88, manufactured by ELDIM Co., Ltd.) during black display of the liquid crystal display device in a dark room. Specifically, the chromaticities u ‘and v’ were calculated at every 15° from the azimuth angle of 0° to 345° at a polar angle of 60° and evaluated based on the following evaluation standards. The results are listed in Table 2.

1. Reddish tint

Redness was evaluated based on the maximum value of u′ (u′max)

A: u′max<0.23

B: 0.23≤u′max<0.26

C: 0.26≤u′max

2. Bluish tint

Blueness was evaluated based on the minimum value of v′(v′min),

A: 0.30≤v′min

B: 0.35≤v′min<0.30

C: v′min<0.35

3. Change in hue

The black display was evaluated visually, and the change in hue at the time of changing the viewing direction was compared.

A: A change in hue due to the viewing direction was hardly found.

B: A change in hue due to the viewing direction was slightly found.

C: A change in hue due to the viewing direction was clearly found.

<Evaluation of Display Unevenness (Evaluation of Display Unevenness in Hot and Humid Environment)>

A thereto test was performed on the prepared liquid crystal display device at 50° C. and a relative humidity of 80% for 72 hours, the backlight of the liquid crystal display device was turned on at 25° C. and a relative humidity of 60%, light leakage during black display at the four corners of the panel after 10 hours from the lighting was imaged from the front of the screen using a camera for measuring the brightness “ProMetric” (manufactured by Radiant Imaging Inc.), and evaluation was performed based on the brightness difference at the four corners where light leakage was large. The results are listed in Table 2.

A: Light leakage at the four corners of the panel was not visually recognized.

(The light leakage of the panel was almost the same as before the thereto input.)

B: Light leakage at the four corners of the panel was visually recognized, but was acceptable.

C: Light leakage at the four corners of the panel was visually recognized, and was not acceptable.

<Evaluation of Durability (Evaluation of Change in Display Performance)>

A thermo test was performed on the prepared liquid crystal display device at 105° C. (the humidity was not particularly set) for 100 hours, the backlight of the liquid crystal display device was turned on at 25° C. and a relative humidity of 60%, and measurement was performed on the panel after 10 hours from the lighting during black display of the liquid crystal display device in a dark room using a measuring device (EZ-Contrast XL88, manufactured by ELDIM Co., Ltd.). The durability was evaluated in comparison with front light leakage, oblique light leakage, and tint before the thermo. The results are listed in Table 2.

[Evaluation Standards for Change in Display Performance]

A: A change from before the thermo injection was not found.

B: A change from before the thermo injection was found, but was acceptable by visual evaluation.

C: A large change from before the therm° injection was found, and was not acceptable by visual evaluation.

### Examples 2 and 3

Liquid crystal display devices of Examples 2 and 3 were prepared in the same manner as in Example 1 except that the retardation was changed by changing the coated film thickness of the first optically anisotropic layer and the second optically anisotropic layer, and evaluation was performed. The results are listed in Table 2.

### Example 4

A liquid crystal display device of Example 4 was prepared in the same manner except that the polarizer was prepared according to the method described in JP2016-148724A, and evaluation was performed. The results are listed in Table 2.

### Example 5

[Preparation of Coating Layer 1]

The following compound was dissolved in methyl ethyl ketone, and the concentration of solid contents was adjusted to 35.6%, thereby obtaining a coating solution for forming a coating layer 1.

Composition of coating solution for forming coating layer 1

Dipentaerythritol hexaacrylate: A-DPH (Shin-Nakamura Chemical Co., Ltd.): 48.5 parts by mass

Pentaerythritol triacrylate: PET30 [manufactured by Nippon Kayaku Co., Ltd.]: 48.5 parts by mass

UV initiator 1: 3.0 parts by mass

Compound B 1: 2.0 parts by mass

The polarizer-side surface of the polarizing plate 2 provided with a single-sided. protective film was coated with the above-described coating solution, dried at 70° C. for 60 seconds, irradiated with UV rays at an irradiation dose of 150 mJ/cm² under a nitrogen condition of 0.1% or less, and cured, thereby forming a coating layer 1 with a film thickness of 4 μm. The film thickness was adjusted by adjusting the coating amount using a slot die according to a die coating method. In this manner, a liquid crystal display device of Example 5 was prepared according to the same method as described above except that the second polarizing plate was prepared, and evaluation was performed.

### Example 6

[Preparation of Composition 2 for Photo-Alignment Film]

8.4 parts by mass of the following copolymer C3 and 0.3 parts by mass of the following thermal acid generator D1 were added to butyl acetate/methyl ethyl ketone (80 parts by mass/20 parts by mass) to prepare a composition for a photo-alignment film.

Copolymer C3 (weight-average molecular weight: 40,000) (hereinafter, compound)

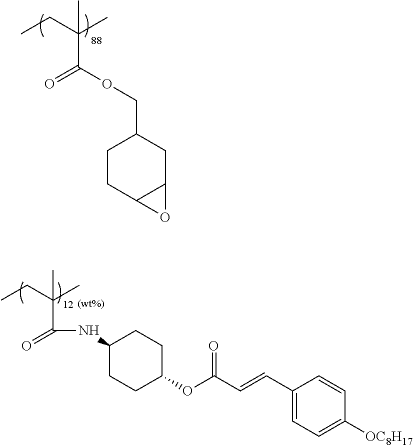

Thermal acid generator D1 (hereinafter, compound)

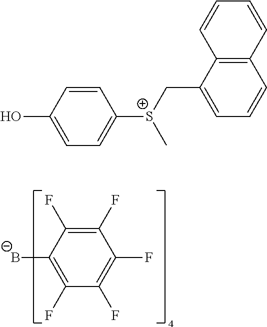

[Preparation of Photo-Alignment Film 2]

One surface of the protective film 2 was coated with the composition 2 for a photo-alignment film prepared previously using a bar coater. After the film was coated with the composition, the obtained film was dried on a hot plate at 80° C. for 5 minutes to remove the solvent, thereby forming a photoisomerizable composition layer with a thickness of 0.2 μm. A photo-alignment film 2 was formed by irradiating the obtained photoisomerizable composition layer with polarized ultraviolet rays (at an irradiation dose of 10 mJ/cm² using an ultrahigh-pressure mercury lamp).

A liquid crystal display device of Example 6 was prepared in the same manner as in Example 4 except that the first optically anisotropic layer was prepared on the prepared photo-alignment film 2 using the composition 3 for forming an optically anisotropic layer and then the second optically anisotropic layer was prepared thereon using the composition 4 for forming an optically anisotropic layer, and evaluation was performed. The results are listed in Table 2.

Composition 3 for forming optically anisotropic layer

Liquid crystal compound R1: 42.00 parts by mass

Liquid crystal compound R2: 42.00 parts by mass

Liquid crystal compound R4: 4.00 parts by mass

Polymerizable compound A1: 12.00 parts by mass

Polymerization initiator S1: 0.50 parts by mass

Leveling agent P1: 0.15 parts by mass

HISOLVE MTEM (manufactured by Toho Chemical Industry Co., Ltd.): 2.00 parts by mass

NK ESTER A-200 (manufactured by Shin-Nakamura Chemical Co., Ltd.): 1.00 parts by mass

Methyl ethyl ketone: 424.8 parts by mass

Liquid crystal compound R4 (hereinafter, compound)

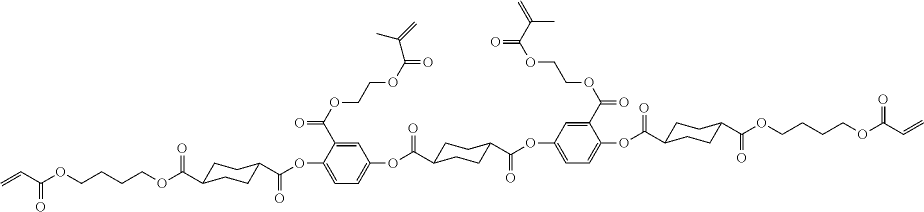 [SMILES: C=CC(=O)OCCCCOC(=O)C1CCC(C(=O)Oc2ccc(OC(=O)C3CCC(C(=O)Oc4ccc(OC(=O)C5CCC(C(=O)OCCCCOC(=O)C=C)CC5)c(C(=O)OCCOC(=O)C(=C)C)c4)CC3)cc2C(=O)OCCOC(=O)C(=C)C)CC1]

Composition 4 for forming optically anisotropic layer

Liquid crystal compound R1: 10.0 parts by mass

Liquid crystal compound R2: 54.0 parts by mass

Liquid crystal compound R3: 28.0 parts by mass

Liquid crystal compound R4: 8.0 parts by mass

Compound B1: 4.5 parts by mass

Monomer K1: 12.0 parts by mass

Polymerization initiator S1: 1.5 parts by mass

Surfactant P2: 0.4 parts by mass

Surfactant P3: 0.5 parts by mass

Acetone: 175.0 parts by mass

Propylene glycol monomethyl acetate: 75.0 parts by mass

### Example 7

A liquid crystal display device of Example 6 was prepared in the same procedures as in Example 6 except that the composition 5 for forming an optically anisotropic layer was used for the second optically anisotropic layer, and evaluation was performed. The results are listed in Table 2.

Composition 5 for forming optically anisotropic layer

Liquid crystal compound R3: 5.0 parts by mass

Liquid crystal compound R5: 42.5 parts by mass

Liquid crystal compound R6: 42.5 parts by mass

Polymerizable compound A1: 10.0 parts by mass

Compound B1: 3.0 parts by mass

Monomer K2: 8.0 parts by mass

Polymerization initiator S1: 5.0 parts by mass

Surfactant P2: 0.3 parts by mass

Surfactant P3: 0.3 parts by mass

Cyclopentanone: 250.0 parts by mass

Liquid crystal compound R5 (hereinafter, compound)

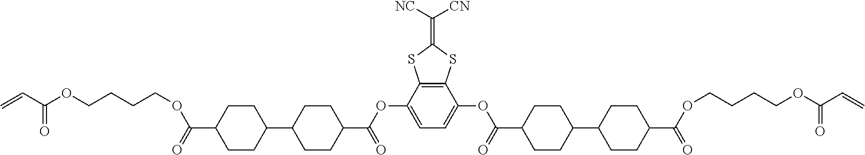 [SMILES: C=CC(=O)OCCCCOC(=O)C1CCC(C2CCC(C(=O)Oc3ccc(OC(=O)C4CCC(C5CCC(C(=O)OCCCCOC(=O)C=C)CC5)CC4)c4c3SC(=C(C#N)C#N)S4)CC2)CC1]

Liquid crystal compound R6 (hereinafter, compound)

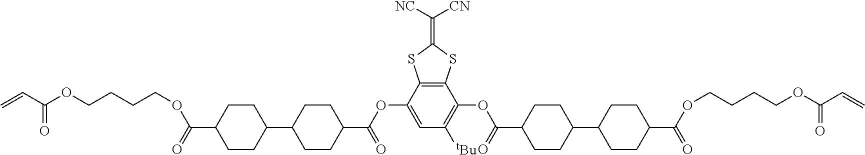 [SMILES: C=CC(=O)OCCCCOC(=O)C1CCC(C2CCC(C(=O)Oc3cc(C(C)(C)C)c(OC(=O)C4CCC(C5CCC(C(=O)OCCCCOC(=O)C=C)CC5)CC4)c4c3SC(=C(C#N)C#N)S4)CC2)CC1]

Monomer K2: VISCOAT #360 (manufactured by Osaka Organic Chemical Industry Ltd.)

### Examples 8 to 14

Liquid crystal display devices of Examples 8 to 14 were prepared in the same procedures as in Example 7 except that optically anisotropic layers having different wavelength dispersions were prepared by changing the mixing ratio of the liquid crystal compounds, and evaluation was performed. The results are listed in Table 2.

### Example 15

A liquid crystal display device of Example 15 was prepared in the same procedures as in Example 1 except that the first optically anisotropic layer was prepared using the following composition 6 for forming an optically anisotropic layer and the second optically anisotropic layer was prepared using the following composition 7 for forming an optically anisotropic layer, and evaluation was performed. The results are listed in Table 2.

Composition 6 for forming optically anisotropic layer

Liquid crystal compound R1: 42.00 parts by mass

Liquid crystal compound R2: 42.00 parts by mass

Polymerizable compound A1: 16.0 parts by mass

Polymerization initiator S4: 3.00 parts by mass

Leveling agent P1: 0.15 parts by mass

HISOLVE MTEM (manufactured by Toho Chemical Industry Co., Ltd.): 2.00 parts by mass

NK ESTER A-200 (manufactured by Shin-Nakamura Chemical Co., Ltd.): 1.00 parts by mass

Methyl ethyl ketone: 424.8 parts by mass

Polymerization initiator S4 (hereinafter, compound)

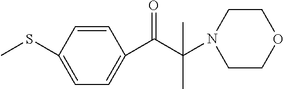 [SMILES: CSc1ccc(C(=O)C(C)(C)N2CCOCC2)cc1]

Composition 7 for forming optically anisotropic layer

Liquid crystal compound R1: 10.0 parts by mass

Liquid crystal compound R2: 54.0 parts by mass

Liquid crystal compound R3: 28.0 parts by mass

Polymerizable compound A1: 8.0 parts by mass

Compound B1: 1.5 parts by mass

Monomer K1: 8.0 parts by mass

Polymerization initiator S4: 3.0 parts by mass

Surfactant P2: 0.4 parts by mass

Surfactant P3: 0.5 parts by mass

Acetone: 175.0 parts by mass

Propylene glycol monomethyl ether acetate: 75.0 parts by mass

### Example 16

A liquid crystal display device of Example 16 was prepared according to the same method as in Example 1 except that the second optically anisotropic layer was prepared using the following composition 8 for forming an optically anisotropic layer in place of the composition 2 for forming an optically anisotropic layer, and evaluation was performed. The results are listed in Table 2.

Composition 8 for forming optically anisotropic layer

Liquid crystal compound R3: 100.0 parts by mass

Compound B1: 4.5 parts by mass

Compound B2: 2.0 parts by mass

Monomer K3: 4.0 parts by mass

Polymerization initiator S2: 5.0 parts by mass

Polymerization initiator S3: 2.0 parts by mass

Surfactant P2: 0.4 parts by mass

Surfactant P3: 0.5 parts by mass

Acetone: 386.4 parts by mass

Propylene glycol monomethyl ether acetate: 71.0 parts by mass

Methanol: 14.2 parts by mass

Compound B2 (hereinafter, compound)

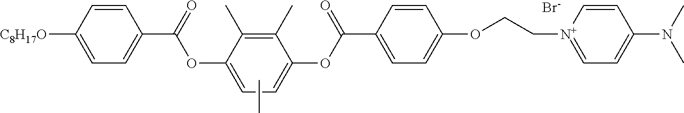

Monomer K3: A-TMMT (manufactured by Shin-Nakamura Chemical Co., Ltd.)

In the embodiments of Examples 1 to 16 described above, even in a case where the polarizer and the optically anisotropic layer were bonded to each other according to the following method, satisfactory adhesiveness was obtained, and the same performance (light leakage suppression, the display performance, and the durability) was obtained as in a case where the polarizer and the optically anisotropic layer were bonded to each other using the 3% PVA aqueous solution described above.

The surface on which the optically anisotropic layer was attached to the polarizer was subjected to a corona treatment at a discharge amount of 125 W·min/m², and the surface was coated with the adhesive liquid A such that the film thickness thereof was set to 0.5 μm. Thereafter, the adhesive-coated surface was attached to the polarizer, and the surface was irradiated with ultraviolet rays from the optical compensation layer side at an irradiation dose of 300 mJ/cm² at 40° C. in an air atmosphere. Next, the obtained film was dried at 60° C. for 3 minutes, and the protective film was peeled off, thereby preparing a first polarizing plate.

### Comparative Example 1

<Preparation of Second Optically Anisotropic Layer From Which Liquid Crystal Layer Can Be Separated>

A TAC (cellulose-based polymer film; TG40, manufactured by Fujifilm Corporation) was coated with the following composition 9 for forming an optically anisotropic layer using a wire bar. The composition was heated at a temperature of 40° C. for 60 seconds for the purpose of drying the solvent in the composition and aging of the alignment of the liquid crystal compound. Next, the obtained film was irradiated with ultraviolet rays (at an irradiation dose of 300 mJ/cm²) at 40° C. and an oxygen concentration of 100 ppm under a nitrogen purge so that the alignment of the liquid crystal compound was fixed, thereby preparing a second optically anisotropic layer in which the liquid crystal layer was able to be peeled off from the TAC support.

Composition 9 for forming optically anisotropic layer

Liquid crystal compound R1: 10.0 parts by mass

Liquid crystal compound R2: 54.0 parts by mass

Liquid crystal compound R3: 28.0 parts by mass

Polymerizable compound A1: 8.0 parts by mass

Compound B2: 2.0 parts by mass

Monomer K: 8.0 parts by mass

Polymerization initiator S2: 5.0 parts by mass

Polymerization initiator S3: 2.0 parts by mass

Surfactant P2: 0.4 parts by mass

Surfactant P4: 0.3 parts by mass

Polymer compound C1: 5.0 parts by mass

Toluene: 621.0 parts by mass

Methyl ethyl ketone: 69.0 parts by mass

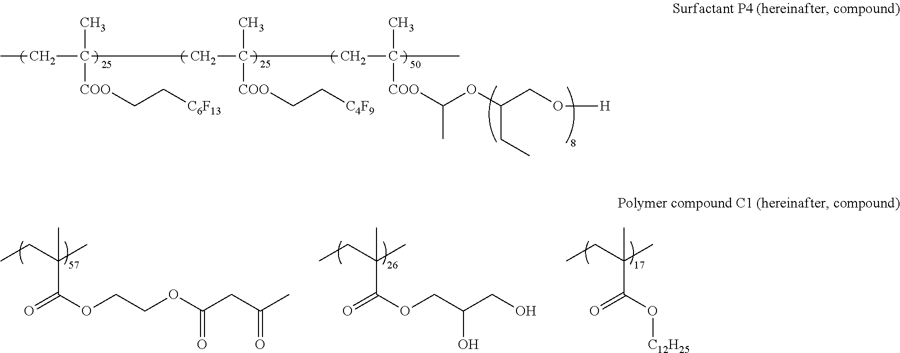

The coating surface side of the peelable second optically anisotropic layer prepared as described above was attached to a glass plate using a 20 μm acrylic pressure sensitive adhesive, the TAC support was peeled off to obtain a film formed of the single second optically anisotropic layer, and the phase difference thereof was measured. As the result, Re (550) was 0 nm, and Rth (550) was −100 nm.

The coating surface side of the peelable second optically anisotropic layer prepared as described above was directly attached to the first optically anisotropic layer 1 using a 15 μm acrylic pressure sensitive adhesive, and the TAC support was peeled off to obtain a laminate in which the first optically anisotropic layer and the second optically anisotropic layer were laminated using a pressure sensitive adhesive. The surface of the second optically anisotropic layer from which the TAC support had been peeled off was subjected to a corona treatment at a discharge amount of 150 W·min/², and the surface was coated with the adhesive liquid A such that the film thickness thereof was set to 0.5 μm. Thereafter, the adhesive-coated surface was attached to the polarizer surface of the polarizing plate 1 provided with a single-sided protective film, and the surface was irradiated with ultraviolet rays from the first optically anisotropic layer 1 on a base material side at an irradiation dose of 300 mJ/cm² at 40° C. in an air atmosphere. Thereafter, the surface was dried at 60° C. for 3 minutes, and the protective film 2 of the first optically anisotropic layer 1 was peeled off, thereby preparing a second polarizing plate in the form of the first optically anisotropic layer and the second optically anisotropic layer being attached to each other using a pressure sensitive adhesive. At this time, the film thickness of the first optically anisotropic layer and the second optically anisotropic layer in the laminated form was 19 μm.

A liquid crystal display device of Comparative Example 1 was prepared using the prepared first polarizing plate according to the same method as in Example 1, and evaluation was performed. The results are listed in Table 2.

### Comparative Example 2

<Formation of First Optically Anisotropic Layer>

1 g of the compound 1 described in WO2013-018526A, 30 mg of a photopolymerization initiator (trade name: IRGACURE 907, manufactured by BASF SE) 30 mg, and 100 mg of a 1% cyclopentanone solution of a surfactant (trade name: KH-40, manufactured by AGC Belau Chemical Co., Ltd.) were dissolved in 2.3 g of cyclopentanone. This solution was filtered through a disposable filter having a pore size of 0.45 μm to obtain a liquid crystal composition.

The polarizer-side surface of the polarizing plate 1 provided with a single-sided protective film which had been subjected to a rubbing treatment orthogonally to the absorption axis of the polarizer, that is, orthogonally to the longitudinal direction of the polarizer was coated with the above-described liquid crystal composition using a wire bar. The coated film was dried at 90° C. for 30 seconds to form a liquid crystal layer having a film thickness of 2 μm. Thereafter, the layer was irradiated with ultraviolet rays at an irradiation dose of 2000 mJ/cm² from the coating surface side of the liquid crystal layer, thereby obtaining a first optically anisotropic layer.

A first optically anisotropic layer was formed on a glass substrate under the same conditions as in Example 1, and the light incidence angle dependence of Re and Rth of only the first optically anisotropic layer was measured. As the result, Re at a wavelength of 550 nm was 130 nm, and Rth at a wavelength of 550 nm was 65 nm.

A first polarizing plate was prepared by fol wing a second optically anisotropic layer on the prepared first optically anisotropic layer according to the same method as in Example 1 setting the lamination order of the first optically anisotropic layer and the second optically anisotropic layer to be opposite to that of Example 1, and allowing the slow axis of the first optically anisotropic layer to be orthogonal to the absorption axis of the first polarizer.

A liquid crystal display device was prepared in the same manner as in Example I except that the first polarizing plate prepared in the above-described manner was used, and evaluation was performed. The results are listed in Table 2.

### Comparative Example 3

A liquid crystal display device of Comparative Example 4 was prepared according to the same method as in Example 1 except that a phase difference film 1 described in JP2016-148724A was attached in place of the first optically anisotropic layer and the second optically anisotropic layer such that the absorption axis of the first polarizer and the slow axis of the phase difference film were parallel to each other, and evaluation was performed. The results are listed in Table 2.

The columns of “slow axis” in Table 2 show the relationship between the absorption axis of the first polarizer and the slow axis of the first optically anisotropic layer, and “parallel” indicates that both the absorption axis and the slow axis are parallel to each other, and “orthogonal” means that both the absorption axis and the slow axis are orthogonal to each other.

The columns of “film thickness of entire anisotropic layer” in Table 2 indicates the film thickness of the first optically anisotropic layer and the second optically anisotropic layer in the laminated form.

TABLE 2

| | First polarizing plate | | | | | | | | | | | | | | | Second polarizing plate | | | | | | | | |
|---|---|---|---|---|---|---|---|---|---|---|---|---|---|---|---|---|---|---|---|---|---|---|---|---|
| | | | | | | | | | | | | | | Film | Film | Protec- | | | | | | | | |
| | Protec- | First | | | | | | | | | | | | thick- | thick- | tive | Second | Protec- | | | | | | |
| | tive | polar- | | | | | | | Second optically | | | | | ness | ness | layer on | polar- | tive | | | | | | |
| | layer | izer | First optically anisotropic layer | | | | | | anisotropic layer | | | | | of entire | of entire | cell side | izer | layer | Evaluation | | | | | |
| | Film | Film | | | | Re1 | | Film | | | | Rth2 | Film | aniso- | polar- | Film | Film | Film | | Tint | | | | Change in |
| | thick- | thick- | | Re1 | Re1 | (450)/ | Rth1 | thick- | Re2 | Rth2 | Rth2 | (450)/ | thick- | trophic | izing | thick- | thick- | thick- | Oblique | Redd- | Blu- | Change | Display | display |
| | ness | ness | Slow | (450) | (550) | Rel | (550) | ness | (550) | (450) | (550) | Rth2 | ness | layer | plate | ness | ness | ness | light | ish | ish | in | uneven- | perfor- |
| | (μm) | (μm) | axis | (nm) | (nm) | (550) | (nm) | (μm) | (nm) | (nm) | (nm) | (550) | (μm) | (μm) | (μm) | (μm) | (μm) | (μm) | leakage | tint | tint | tint | ness | mance |
| Example | 25 | 15 | Parallel | 110 | 130 | 0.85 | 65 | 2 | 0 | −95 | −100 | 0.95 | 2 | 4 | 44 | 20 | 15 | 25 | A | B | B | B | B | A |
| 1 | | | | | | | | | | | | | | | | | | | | | | | | |
| Example | 25 | 15 | Parallel | 105 | 120 | 0.88 | 60 | 1.9 | 0 | −95 | −100 | 0.95 | 2 | 4 | 44 | 20 | 15 | 25 | B | C | A | B | B | A |
| 2 | | | | | | | | | | | | | | | | | | | | | | | | |
| Example | 25 | 15 | Parallel | 110 | 130 | 0.85 | 65 | 2 | 0 | −85 | −90 | 0.94 | 1.8 | 4 | 44 | 20 | 15 | 25 | B | B | B | B | B | A |
| 3 | | | | | | | | | | | | | | | | | | | | | | | | |
| Example | 25 | 5 | Parallel | 110 | 130 | 0.85 | 65 | 2 | 0 | −95 | −100 | 0.95 | 2 | 4 | 34 | 20 | 5 | 25 | A | B | B | B | A | B |
| 4 | | | | | | | | | | | | | | | | | | | | | | | | |
| Example | 25 | 15 | Parallel | 110 | 130 | 0.85 | 65 | 2 | 0 | −95 | −100 | 0.95 | 2 | 4 | 44 | — | 15 | 25 | A | B | B | B | A | B |
| 5 | | | | | | | | | | | | | | | | | | | | | | | | |
| Example | 25 | 5 | Parallel | 110 | 130 | 0.85 | 65 | 2 | 0 | −95 | −100 | 0.95 | 2 | 4 | 34 | 20 | 5 | 25 | A | B | B | B | A | B |
| 6 | | | | | | | | | | | | | | | | | | | | | | | | |
| Example | 25 | 5 | Parallel | 110 | 130 | 0.85 | 65 | 2 | 0 | −80 | −100 | 0.80 | 2 | 4 | 34 | 20 | 5 | 25 | A | A | B | A | A | B |
| 7 | | | | | | | | | | | | | | | | | | | | | | | | |
| Example | 25 | 5 | Parallel | 110 | 130 | 0.85 | 65 | 2 | 0 | −75 | −100 | 0.75 | 2 | 4 | 34 | 20 | 5 | 25 | A | A | B | B | A | B |
| 8 | | | | | | | | | | | | | | | | | | | | | | | | |
| Example | 25 | 5 | Parallel | 125 | 130 | 0.96 | 65 | 2 | 0 | −95 | −100 | 0.95 | 2 | 4 | 34 | 20 | 5 | 25 | B | B | C | B | A | B |
| 9 | | | | | | | | | | | | | | | | | | | | | | | | |
| Example | 25 | 5 | Parallel | 125 | 130 | 0.96 | 65 | 2 | 0 | −80 | −100 | 0.80 | 2 | 4 | 34 | 20 | 5 | 25 | B | A | C | B | A | B |
| 10 | | | | | | | | | | | | | | | | | | | | | | | | |
| Example | 25 | 5 | Parallel | 105 | 130 | 0.81 | 65 | 2 | 0 | −95 | −100 | 0.95 | 2 | 4 | 34 | 20 | 5 | 25 | A | B | A | B | A | B |
| 11 | | | | | | | | | | | | | | | | | | | | | | | | |
| Example | 25 | 5 | Parallel | 105 | 130 | 0.81 | 65 | 2 | 0 | −80 | −100 | 0.80 | 2 | 4 | 34 | 20 | 5 | 25 | A | A | A | C | A | B |
| 12 | | | | | | | | | | | | | | | | | | | | | | | | |
| Example | 25 | 5 | Parallel | 100 | 130 | 0.77 | 65 | 2 | 0 | −80 | −100 | 0.80 | 2 | 4 | 34 | 20 | 5 | 25 | A | A | A | C | A | B |
| 13 | | | | | | | | | | | | | | | | | | | | | | | | |
| Example | 25 | 5 | Parallel | 100 | 130 | 0.77 | 65 | 2 | 0 | −75 | −100 | 0.75 | 2 | 4 | 34 | 20 | 5 | 25 | A | A | A | C | A | B |
| 14 | | | | | | | | | | | | | | | | | | | | | | | | |
| Example | 25 | 15 | Parallel | 110 | 130 | 0.85 | 65 | 2 | 0 | −95 | −100 | 0.95 | 2 | 4 | 34 | 20 | 5 | 25 | A | B | B | B | B | B |
| 15 | | | | | | | | | | | | | | | | | | | | | | | | |
| Example | 25 | 15 | Parallel | 110 | 130 | 0.85 | 65 | 2 | 0 | −105 | −100 | 1.05 | 2 | 4 | 44 | 20 | 15 | 25 | B | C | C | C | B | A |
| 16 | | | | | | | | | | | | | | | | | | | | | | | | |
| Compar- | 25 | 15 | Parallel | 110 | 130 | 0.85 | 65 | 2 | 0 | −95 | −100 | 0.95 | 2 | 19 | 59 | 20 | 15 | 25 | A | B | B | B | C | A |
| ative | | | | | | | | | | | | | | | | | | | | | | | | |
| Example | | | | | | | | | | | | | | | | | | | | | | | | |
| 1 | | | | | | | | | | | | | | | | | | | | | | | | |
| Compar- | 25 | 15 | Ortho- | 115 | 130 | 0.88 | 65 | 2 | 0 | −115 | −120 | 0.96 | 2 | 4 | 44 | 20 | 15 | 25 | A | B | B | B | B | C |
| ative | | | gonal | | | | | | | | | | | | | | | | | | | | | |
| Example | | | | | | | | | | | | | | | | | | | | | | | | |
| 2 | | | | | | | | | | | | | | | | | | | | | | | | |
| Compar- | 25 | 15 | Parallel | 275 | 275 | 1.00 | 0 | 15 | — | — | — | — | — | 15 | 55 | 20 | 15 | 25 | A | B | C | A | C | A |
| ative | | | | | | | | | | | | | | | | | | | | | | | | |
| Example | | | | | | | | | | | | | | | | | | | | | | | | |
| 3 | | | | | | | | | | | | | | | | | | | | | | | | |

### Examples 17 to 20

<Preparation of IPS Mode Liquid Crystal Cell>

First, an IPS mode liquid crystal cell which had a liquid crystal layer between two sheets of glass substrates and in which the gap (d) between the substrates was approximately 4.0 μm was prepared. Further, Δn of the liquid crystal compound in the liquid crystal layer was 0.08625, and the values of Δn·d are listed in Table 3.

At the time of formation of a liquid crystal cell, a glass substrate was subjected to a photo-alignment treatment with reference to Example 11 of JP2005-351924A to form an alignment layer, and the liquid crystal compound in the liquid crystal cell was aligned. The tilt angle of the liquid crystal compound with respect to the substrate surface was 0.1°. A blue color filter, a green color filter, and a red color filter having different values of Rth were formed on the substrate of the liquid crystal cell on the viewing side, and liquid crystal cells 1 to 4 listed in Table 3 were formed. In a case where the wavelength showing the maximum transmittance of the blue color filter was set as λ₁, the wavelength showing the maximum transmittance of the green color filter was set as λ₂, and the wavelength showing the maximum transmittance of the red color filter was set as λ₃, the respective wavelengths satisfied the relationship of λ₁<λ₂<λ₃ in each liquid crystal cell. Further, Rth of each color filter disposed on the formed liquid crystal cell at each wavelength is collectively listed in Table 3. The value of Rth of each color filter was adjusted by adjusting the film thickness of the color filter, adding a retardation enhancer (for example, a compound represented by Formula (X)) or a retardation reducing agent (for example, a compound represented by Formula (XI)) to the material for forming the color filter layer, or adjusting the addition amount thereof. Further, Rth (550) of the rear substrate (the lower substrate of the liquid crystal cell) of the prepared liquid crystal cell was 0 nm.

TABLE 3

| | | Color filter | | | | |
|---|---|---|---|---|---|---|
| | Rth (550) | Rth | Rth | Rth | Tilt | |
| | of rear | (λ₁) | (λ₂) | (λ₃) | angle | |
| | substrate | (nm) | (nm) | (nm) | (°) | Δnd |
| Liquid | 0 | 10 | 10 | 10 | 0.1 | 345 |
| crystal cell 1 | | | | | | |
| Liquid | 0 | 10 | 10 | 30 | 0.1 | 330 |
| crystal cell 2 | | | | | | |
| Liquid | 0 | 45 | 10 | 10 | 0.1 | 350 |
| crystal cell 3 | | | | | | |
| Liquid | 0 | 0 | 10 | 20 | 0.1 | 355 |
| crystal cell 4 | | | | | | |

The liquid crystal display devices of Examples 17 to 20 were prepared in the same procedure as in Example 6 except that the liquid crystal cell prepared in the above-described mariner was used, and evaluation was performed. The results are shown in Table 4 below.

TABLE 4

| | First polarizing plate | | | | | | | | | | | | |
|---|---|---|---|---|---|---|---|---|---|---|---|---|---|
| | Protective | First | | | | | | | | | | | |
| | layer | polarizer | First optically anisotropic layer | | | | | | Second optically anisotropic layer | | | | |
| | Film | Film | | | | Re | | Film | | | | Re | Film |
| | thick- | thick- | | Re1 | Re1 | (450)/ | Rth1 | thick- | Re2 | Rth2 | Rth2 | (450)/ | thick- |
| | ness | ness | Slow | (450) | (550) | Re | (550) | ness | (550) | (450) | (550) | Re | ness |
| | (μm) | (μm) | axis | (nm) | (nm) | (550) | (nm) | (μm) | (nm) | (nm) | (nm) | (550) | (μm) |
| Example 17 | 25 | 5 | Parallel | 110 | 130 | 0.85 | 65 | 2 | 0 | −95 | −100 | 0.95 | 2 |
| Example 18 | 25 | 5 | Parallel | 110 | 130 | 0.85 | 65 | 2 | 0 | −95 | −100 | 0.95 | 2 |
| Example 19 | 25 | 5 | Parallel | 110 | 130 | 0.85 | 65 | 2 | 0 | −95 | −100 | 0.95 | 2 |
| Example 20 | 25 | 5 | Parallel | 110 | 130 | 0.85 | 65 | 2 | 0 | −95 | −100 | 0.95 | 2 |
| | First polarizing plate | | | Second polarizing plat | | | | | | | | | |
| | Film | Film | | Protective | | | | | | | | | |
| | thick- | thick- | | layer on | | Protective | | | | | | | |

| | | | | | |
|---|---|---|---|---|---|
| ness | ness | cell side | Polarizer | layer | Evaluation |

| | of entire | of entire | | Film | Film | Film | | Tint | | | | |
|---|---|---|---|---|---|---|---|---|---|---|---|---|
| | anisotrophic | polarizing | Liquid | thick- | thick- | thick- | Oblique | | | Change | | Change in |
| | layer | plate | crystal | ness | ness | ness | light | Reddish | Bluish | in | Display | display |
| | (μm) | (μm) | cell | (μm) | (μm) | (μm) | leakage | tint | tint | tint | unevenness | performance |
| Example 17 | 4 | 34 | 1 | 20 | 5 | 25 | A | B | B | B | A | B |
| Example 18 | 4 | 34 | 2 | 20 | 5 | 25 | A | A | B | B | A | B |
| Example 19 | 4 | 34 | 3 | 20 | 5 | 25 | A | A | C | A | A | B |
| Example 20 | 4 | 34 | 4 | 20 | 5 | 25 | A | A | A | C | A | B |

### EXPLANATION OF REFERENCES

1: first polarizer protective layer
2: first polarizer
3: absorption axis of second polarizer
4: second optically anisotropic layer
5: first optically anisotropic layer
6: slow axis of first optically anisotropic layer
7: upper substrate of liquid crystal cell
8: liquid crystal layer
9: lower substrate of liquid crystal cell
10: polarizer protective layer on liquid crystal cell side of second polarizer
11: second polarizer
12: absorption axis of second polarizer
13: second polarizer protective layer
14: backlight unit
15: optical compensation layer
16: first polarizing plate
17: second polarizing plate

What is claimed is:

1. A liquid crystal display device comprising at least:
a first polarizer;
a second optically anisotropic layer;
a first optically anisotropic layer;
a liquid crystal cell; and
a second polarizer, in this order,
wherein the liquid crystal cell includes a pair of substrates, at least one of which has an electrode, disposed to oppose each other and a liquid crystal layer disposed between the pair of substrates and having a controlled alignment,
an electric field which has a component parallel to the substrate having the electrode is formed by the electrode,
an absorption axis of the first polarizer is parallel with a slow axis of the first optically anisotropic layer,
the absorption axis of the first polarizer is orthogonal to a slow axis of the liquid crystal layer having a controlled alignment during black display,
the absorption axis of the first polarizer is orthogonal to an absorption axis of the second polarizer,
an in-plane retardation Re1 (550) of the first optically anisotropic layer at a wavelength of 550 nm and a retardation Rth1 (550) of the first optically anisotropic layer in a thickness direction each satisfy Expression (1) and Expression (2),
80 nm≤Re1 (550)≤160 nm Expression (1)
40 nm≤Rth1 (550)≤80 nm Expression (2)
an in-plane retardation Re2 (550) of the second optically anisotropic layer at a wavelength of 550 nm and a retardation Rth2 (550) of the second optically anisotropic layer in a thickness direction each satisfy Expression (3) and Expression (4), and
0 nm≤Re2 (550)≤10 nm Expression (3)
−150 nm≤Rth2 (550)≤−70 nm Expression (4)
a film thickness of the first optically anisotropic layer and the second optically anisotropic layer in a laminated form is 8 μm or less.

2. The liquid crystal display device according to claim 1,
wherein the film thickness of the first optically anisotropic layer and the second optically anisotropic layer in the laminated form is 5 μm or less,

3. The liquid crystal display device according to claim 1,
wherein the first optically anisotropic layer is a layer in which a rod-like liquid crystal compound is fixed in a state of being aligned in a direction horizontal to a substrate surface.

4. The liquid crystal display device according to claim 1,
wherein the second optically anisotropic layer is a layer in which the rod-like liquid crystal compound is fixed in a state of being aligned in a direction perpendicular to the substrate surface.

5. The liquid crystal display device according to claim 1,
wherein an in-plane retardation Re1 (450) of the first optically anisotropic layer at a wavelength of 450 nm and the in-plane retardation Re1 (550) of the first optically anisotropic layer at a wavelength of 550 nm satisfy Expression (5).
Re1 (450)/Re1 (550)≤1.00 Expression (5)

6. The liquid crystal display device according to claim 1,
wherein a retardation Rth2 (450) of the second optically anisotropic layer at a wavelength of 450 nm in the thickness direction and the retardation Rth2 (550) of the second optically anisotropic layer at a wavelength of 550 nm in the thickness direction satisfy Expression (6).
Rth2 (450)/Rth2 (550)≤1.00 Expression (6)

7. The liquid crystal display device according to claim 1,
wherein a retardation Rth2 (450) of the second optically anisotropic layer at a wavelength of 450 nm in the thickness direction and the retardation Rth2 (550) of the second optically anisotropic layer at a wavelength of 550 nm in the thickness direction satisfy Expression (7).
Rth2 (450)/Rth2 (550)≤0.82 Expression (7)

8. The liquid crystal display device according to claim 1,
wherein the first optically anisotropic layer and the second optically anisotropic layer are adjacent to each other.

9. The liquid crystal display device according to claim 1,
wherein a film thickness of a first polarizing plate which includes the first polarizer, the first optically anisotropic layer, and the second optically anisotropic layer is 50 μm or less.

10. The liquid crystal display device according to claim 1,
wherein the second optically anisotropic layer is bonded to the first polarizer through a polyvinyl alcohol-based adhesive.

11. The liquid crystal display device according to claim 1,
wherein the second optically anisotropic layer is bonded to the first polarizer through a curable adhesive composition which is cured by being irradiated with active energy rays or being heated.

12. The liquid crystal display device according to claim 1,
wherein at least one of the first optically anisotropic layer or the second optically anisotropic layer is a layer in which an alignment state of a polymerizable liquid crystal compound is fixed by using an oxime ester-based photopolymerization initiator.

13. The liquid crystal display device according to claim 1,
wherein the second optically anisotropic layer is formed using a liquid crystal composition which contains at least a liquid crystal compound and a compound represented by Formula (I),
(Z)ₙ-L-(Q)ₘ Formula (I)
in Formula (I), Z represents a substituent containing a polymerizable group, n represents an integer of 0 to 4, and in a. case where n represents an integer of 2 to 4, two or more of Z's may be the same as or different from each other,
Q represents a substituent containing at least one boron atom, m represents 1 or 2, and in a case where m represents 2, two Q's may be the same as or different from each other,
L represents an (n+m)-valent linking group, and Here, in a case where n represents 0 and m represents 1, L represents a hydrogen atom, a substituted or unsubstituted alkyl group, a substituted or unsubstituted alkenyl group, a substituted or unsubstituted alkynyl group, a substituted or unsubstituted aryl group, or a substituted or unsubstituted heteroaryl group.

14. The liquid crystal display device according to claim 1,
wherein the liquid crystal cell includes at least a first pixel region, a second pixel region, and a third pixel region,
a first color filter disposed on the first pixel region of the liquid crystal cell, a second color filter disposed on the second pixel region of the liquid crystal cell, and a third color filter disposed on the third pixel region of the liquid crystal cell are provided on a side closer to a viewing side than the liquid crystal cell,
a relationship of λ1<λ2<λ3 is satisfied in a case where a wavelength showing a maximum transmittance of the first color filter is set as λ₁, a wavelength showing a maximum transmittance of the second color filter is set as λ₂, and a wavelength showing a maximum transmittance of the third color filter is set as λ₃, and
a retardation Rth (λ₁) of the first color filter at a wavelength λ₁ in the thickness direction and a retardation Rth (λ₂) of the second color filter at a wavelength λ₂ in the thickness direction satisfy Expression (8).
Rth (λ₂)≤Rth (λ₃) Expression (8)

15. The liquid crystal display device according to claim 1,
wherein a retardation Rth (λ₂) of the second color filter at a wavelength λ₂ in the thickness direction and a retardation Rth (λ₃) of the third color filter at a wavelength λ₃ in the thickness direction satisfy Expression (9).
Rth (λ₂)≤Rth (λ₃) Expression (9)

16. The liquid crystal display device according to claim 2,
wherein the first optically anisotropic layer is a layer in which a rod-like liquid crystal compound is fixed in a state of being aligned in a direction horizontal to a substrate surface.

17. The liquid crystal display device according to claim 2,
wherein the second optically anisotropic layer is a layer in which the rod-like liquid crystal compound is fixed in a state of being aligned in a direction perpendicular to the substrate surface.

18. The liquid crystal display device according to claim 2,
wherein an in-plane retardation Re1 (450) of the first optically anisotropic layer at a wavelength of 450 nm and the in-plane retardation Re1 (550) of the first optically anisotropic layer at a wavelength of 550 nm satisfy Expression (5).
Re1 (450)/Re1 (550)≤1.00 Expression (5)

19. The liquid crystal display device according to claim 2,
wherein a retardation Rth2 (450) of the second optically anisotropic layer at a wavelength of 450 nm in the thickness direction and the retardation Rth2 (550) of the second optically anisotropic layer at a wavelength of 550 nm in the thickness direction satisfy Expression (6).
Rth2 (450)/Rth2 (550)≤1.00 Expression (6)

20. The liquid crystal display device according to claim 2,
wherein a retardation Rth2 (450) of the second optically anisotropic layer at a wavelength of 450 nm in the thickness direction and the retardation Rth2 (550) of the second optically anisotropic layer at a wavelength of 550 nm in the thickness direction satisfy Expression (7).
Rth2 (450)/Rth2 (550)≤0.82 Expression (7)
